(19) United States
(12) Patent Application Publication
(10) Pub. No.: US 2026/0303750 A1
(43) Pub. Date: Oct. 1, 2026

(54) IMAGE READING DEVICE AND IMAGE READING METHOD

(71) Applicant: SEIKO EPSON CORPORATION, TOKYO (JP)

(72) Inventor: Yasuhisa YAMAMOTO, KITAKYUSHU-SHI (JP)

(21) Appl. No.: 19/463,278

(22) Filed: Jan. 29, 2026

(30) Foreign Application Priority Data
Jan. 29, 2025 (JP) 2025-012625

(51) Int. Cl. H04N 1/387; H04N 1/00; H04N 1/393

(52) U.S. Cl. CPC H04N 1/3876; H04N 1/00005; H04N 1/00037; H04N 1/3878; H04N 1/3935

(57) ABSTRACT

An image reading device includes a reading section configured to read a document having a first surface and a second surface and a control section wherein after reading a first image of the first surface and a second image of the second surface, the control section determines, based on a size of the first image and a size of the second image, a size of a composite image that includes the first image and the second image and that includes a predetermined margin, and generates the composite image by allocating the first image and the second image within a range of the determined size.

### CROSS-REFERENCE TO RELATED APPLICATION

The present application is based on, and claims priority from JP Application Serial Number 2025-012625, filed Jan. 29, 2025, the disclosure of which is hereby incorporated by reference herein in its entirety.

### BACKGROUND

### 1. Technical Field

The present disclosure relates to an image reading device and an image reading method for reading a document having a first surface and a second surface.

### 2. Related Art

As an image reading device, a copying machine capable of copying both sides of an identification (ID) card on a single copy sheet is known. As the copy sheet, a standard sheet of a predetermined size such as a A4 sheet is used. For example, the user can copy the front and back sides of the ID card on a single A4 sheet by causing the copying machine to read the ID card with the front side of the ID card facing a predetermined position on the document base and subsequently causing the copier to read the ID card with the back side of the ID card facing a predetermined position on the document base. An A5 size read image including a

copy image of the front side of the ID card and an A5 size read image including a copy image of the back side of the ID card are arranged on the A4 sheet. Therefore, if the ID card is much smaller than A5 size, there will be a wide blank space in the A4 sheet, such as a wide gap between the copy images.

A digital multi-function device disclosed in JP-A 2019-4298 separately reads the front and back sides of a card such as a business card, allocates the obtained image data to a layout of a predetermined sheet size, and prints the image data on a sheet of the predetermined size in accordance with the layout.

In the digital multi-function device described above, the size of the layout, in which the image data that was obtained by reading the front and back sides of the card is allocated, is fixed to the size of the sheet. Therefore, when the card is considerably smaller than 1/2 the size of the sheet, a wide blank space is generated in the sheet, such as a wide gap between image data.

### SUMMARY

An image reading device has an aspect including a reading section configured to read a document having a first surface and a second surface and a control section configured to perform processes on read data generated by the reading section, wherein the read data includes first read data generated by reading the first surface and second read data generated by reading the second surface and the control section performs a first cutting out process of, based on the first read data, extracting, from a background, a first image corresponding to the first surface, a second cutting out process of, based on the second read data, extracting, from a background, a second image corresponding to the second surface, a size determination process of determining, based on a size of the first image and a size of the second image, a size of a composite image that includes the first image and the second image and that includes a predetermined margin, and a composite image output process of generating the composite image by allocating the first image and the second image within a range of the determined size, and outputting the composite image.

An image reading method of the present disclosure is image reading method of reading a document having a first surface and a second surface by a reading section and performing processes on read data generated by the reading section, the read data including first read data generated by reading the first surface and second read data generated by reading the second surface, the image reading method including a first cutting out step of, based on the first read data, extracting, from a background, a first image corresponding to the first surface; a second cutting out step of, based on the second read data, extracting, from a background, a second image corresponding to the second surface; a size determining step of, based on a size of the first image and a size of the second image, determining a size of a composite image that includes the first image and the second image and that includes a predetermined margin; a composite image output step of generating the composite image by allocating the first image and the second image within the range of the determined size, and outputting the composite image.

### BRIEF DESCRIPTION OF THE DRAWINGS

FIG. 1 is a diagram schematically illustrating a configuration example of an image reading device.

FIG. 2 is a block diagram schematically illustrating a configuration example of an image reading system.

FIG. 3 is a diagram schematically illustrating an example of ID card scanning of a cut out image composing method.

FIG. 4 is a diagram schematically illustrating an example of ID card scanning of the cut out image composing method.

FIG. 5 is a diagram schematically illustrating examples of allocation of a first image and a second image.

FIG. 6 is a diagram schematically illustrating examples of combinations of reading surfaces.

FIG. 7 is a diagram schematically illustrating display examples of a UI screen.

FIG. 8 is a flowchart schematically illustrating an example of an image reading process.

FIG. 9 is a diagram schematically illustrating display examples of a scanning display screen and a selection screen.

FIG. 10 is a flowchart schematically illustrating an example of a scan process.

FIG. 11 is a diagram schematically illustrating an example of a cutting out process with inclination correction.

FIG. 12 is a flowchart schematically illustrating an example of a layout generation process.

FIG. 13 is a flowchart schematically illustrating an example of an image presence or absence setting process.

FIG. 14 is a flowchart schematically illustrating an example of a composite image generation process.

FIG. 15 is a flowchart schematically illustrating an example of a two image allocation process.

FIG. 16 is a flowchart schematically illustrating an example of a file generation process.

FIG. 17 is a diagram schematically illustrating a display example of a storage completed screen.

FIG. 18 is a flowchart schematically illustrating another example of the image reading process.

FIG. 19 is a flowchart schematically illustrating another example of the image reading process.

FIG. 20 is a diagram schematically illustrating an example of ID card scanning of a read data joining method.

FIG. 21 is a diagram schematically illustrating an example of ID card scanning of the read data joining method.

### DESCRIPTION OF EMBODIMENTS

Hereinafter, embodiments of the present disclosure will be described. Of course, the following embodiments are merely examples of the present disclosure, and all of the features illustrated in the embodiments are not necessarily essential to the disclosed solution.

### 1. Overview of aspects included in the present disclosure

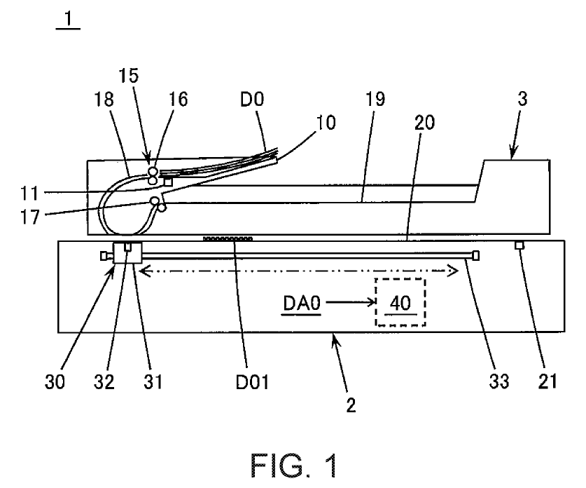

First, an overview of aspects included in the present disclosure will be described with reference to examples illustrated in FIGS. 1 to 21. Note that the drawings of the present application are diagrams schematically illustrating examples, and the enlargement ratios in the respective directions illustrated in these drawings may be different, and the respective drawings may not be consistent. Of course, each element of the present aspect is not limited to the specific examples indicated by the reference numerals. In the "Summary of aspects included in the present disclosure", the term in parentheses means a supplementary explanation of the immediately preceding term.

### First aspect

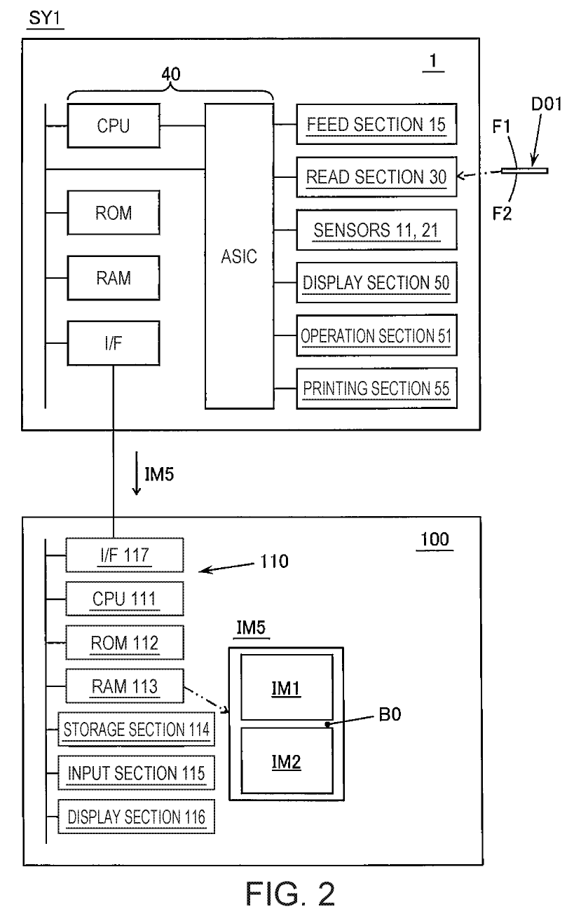

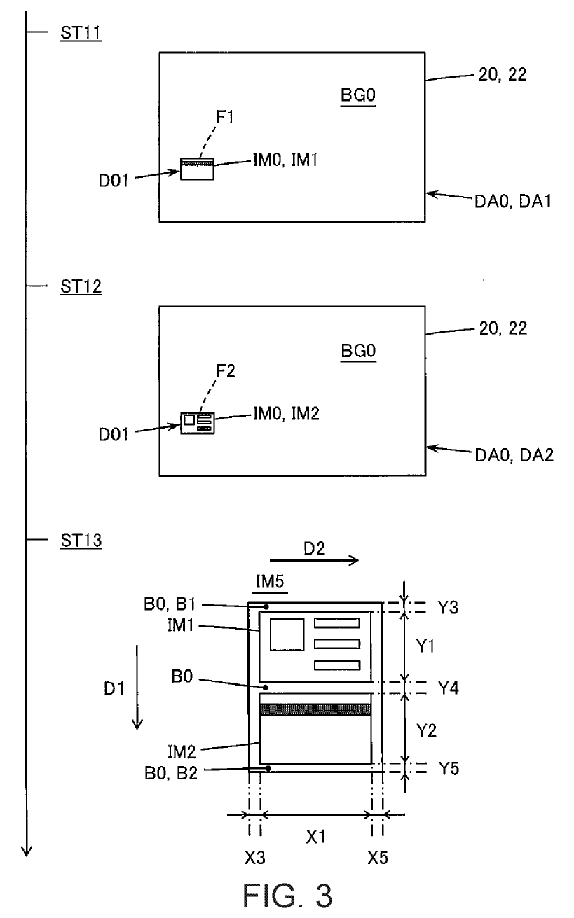

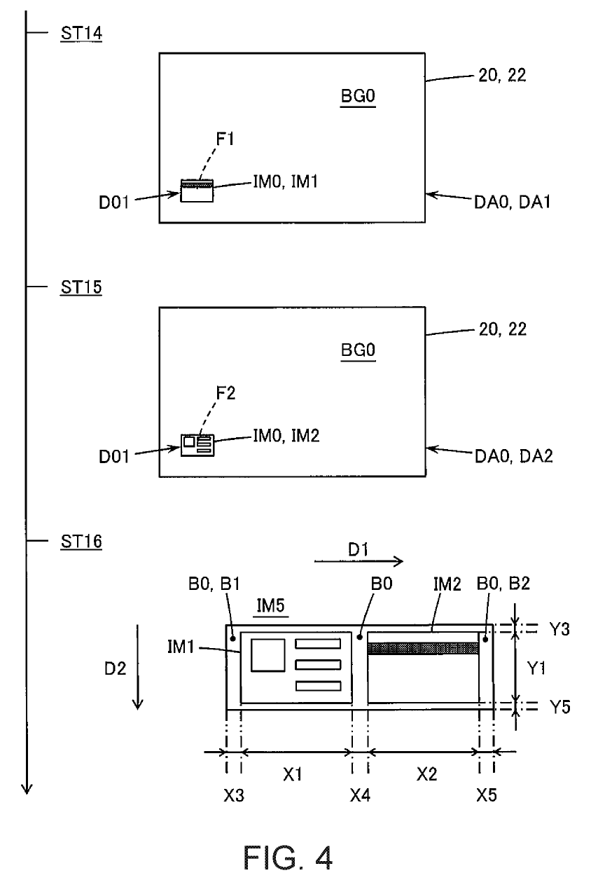

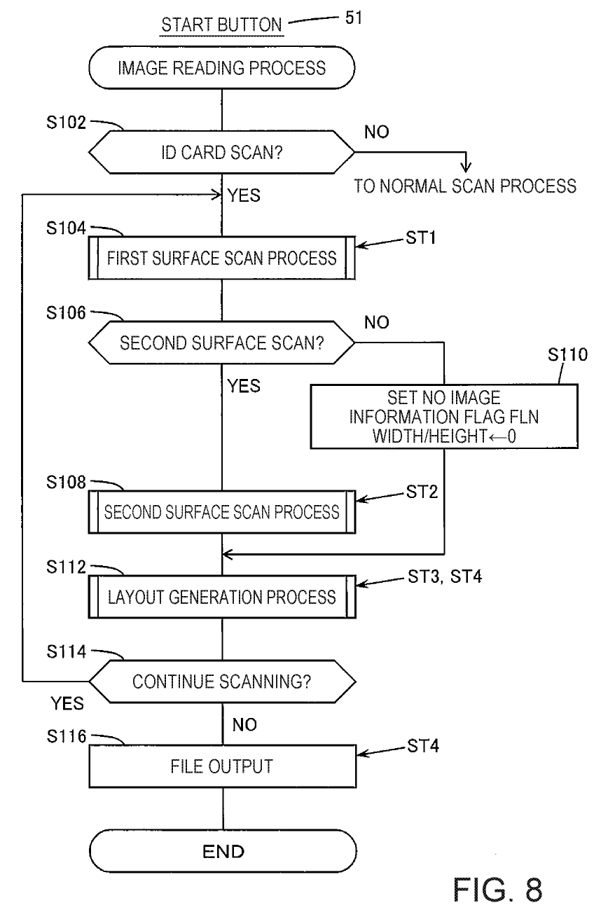

As illustrated in FIGS. 1 and 2, an image reading device 1 according to an aspect includes a reading section 30 that reads a document D0 having a first surface F1 and a second surface F2, and a control section 40 that performs processes on read data DA0 generated by the reading section 30. As illustrated in FIGS. 3 and 4, the read data DA0 includes first read data DA1 generated by reading the first surface F1, and second read data DA2 generated by reading the second surface F2. The control section 40 performs the following processes as illustrated in FIGS. 8, 14 to 16, and the like.

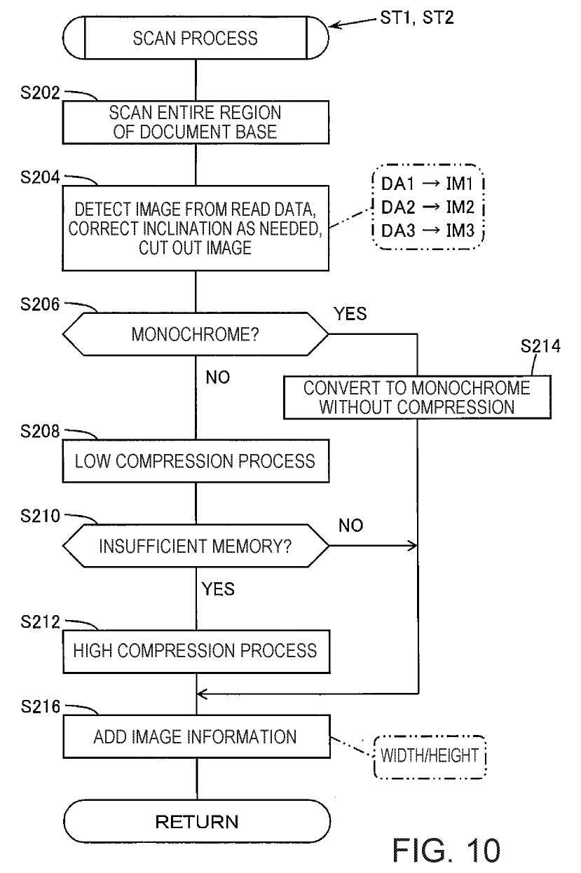

(a1) A first cutting out process (for example, step S104 in FIG. 8 and step S204 in FIG. 10) that, based on the first read data DA1, extracts a first image IM1 corresponding to the first surface F1 from a background BG0.

(a2) A second cutting out process (for example, step S108 in FIG. 8 and step S204 in FIG. 10) that, based on second read data DA2, extracts a second image IM2 corresponding to the second surface F2 from the background BG0.

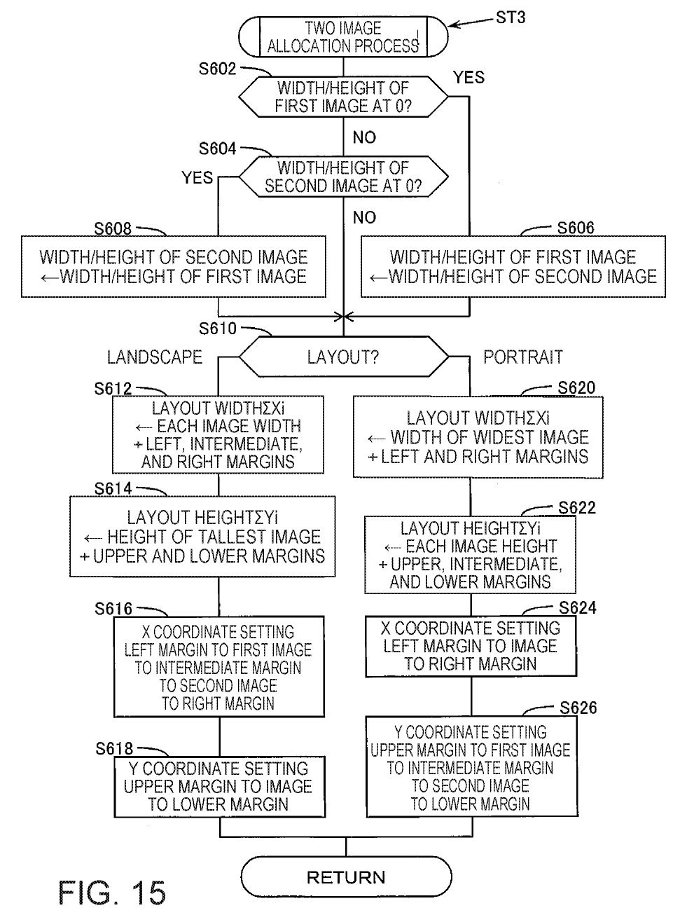

(a3) A size determination process (for example, the two image allocation process in FIG. 15) that, based on the size of the first image IM1 and the size of the second image IM2, determines a size of the composite image IM5, which includes the first image IM1 and the second image IM2 including a predetermined margin B0.

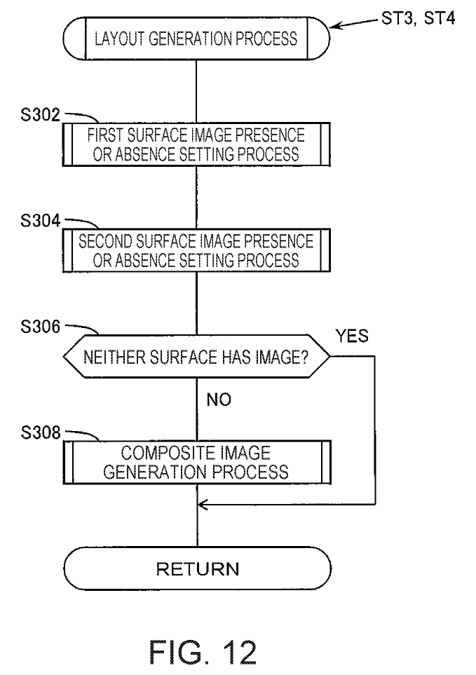

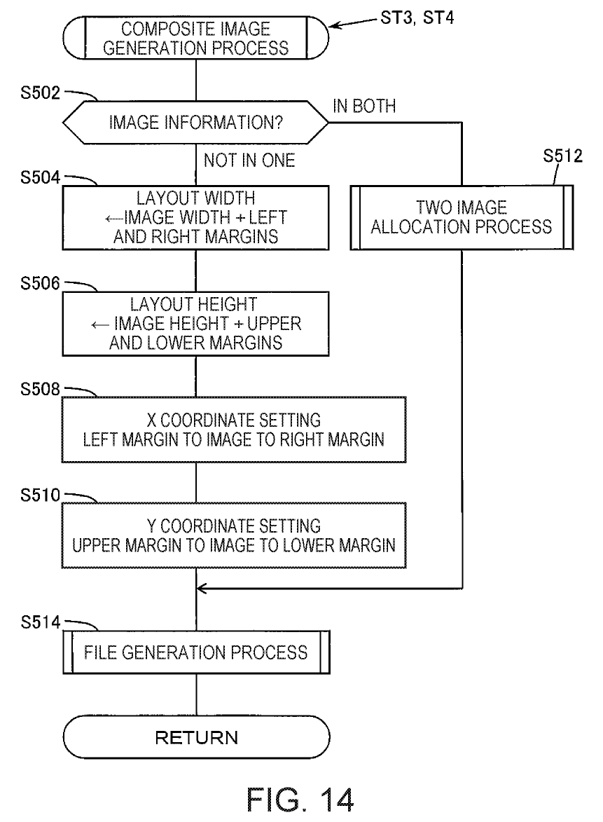

(a4) A composite image output process (for example, steps S112 and S116 in FIG. 8, step S308 in FIG. 12, and the processes in FIGS. 14 to 16) that generates the composite image IM5 by allocating the first image IM1 and the second image IM2 within the range of the determined size, and outputs the composite image IM5.

By cutting out the image IM0 included in the read data DA0 from the background BG0, the document D0 may be arranged anywhere in the reading range, and the blank space in the composite image IM5 including the first image IM1 and the second image IM2 corresponding to the first surface F1 and the second surface F2, respectively, of the document D0 does not become too wide. Therefore, the above aspect can provide an image reading device capable of making an output image obtained by reading a document having a first surface and a second surface easy to view.

The aspects described above include various examples.

Examples of the document include an identification (ID) card, a business card, and a paper certificate. Examples of the ID card include an integrated circuit (IC) card, a magnetic card, a driver's license, a card having a barcode, and a card having a two dimensional code.

The second surface of the document may be a surface on the opposite side to the first surface, or may be a front side of a medium different from the medium having the first surface. Therefore, the document is not limited to one sheet of medium, and may be two or more sheets of medium.

The reading section may perform flatbed scanning or automatic document feeder (ADF) scanning.

The terms "first", "second”, and the like in the present application are used to identify each component included in a plurality of components having similarities, and do not necessarily mean an order.

Of course, the above-described additional remarks are also applied to the following aspects.

### Second aspect

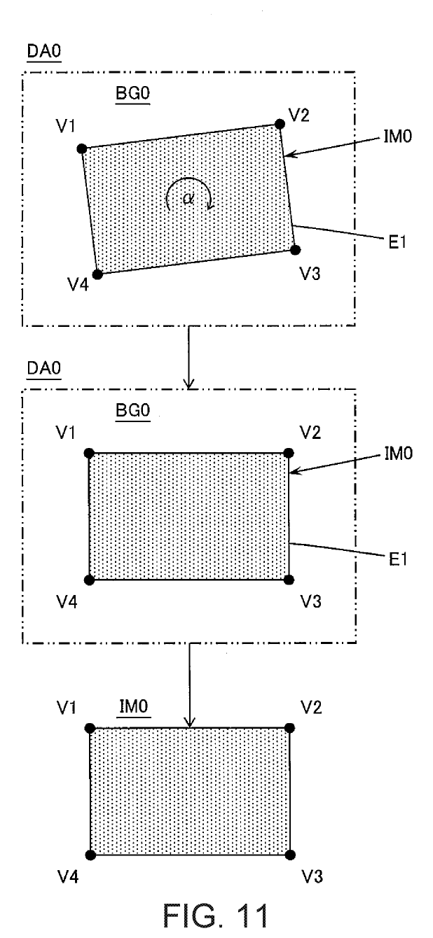

As illustrated in FIGS. 10 and 11, in the first cutting out process, the control section 40 may calculate an inclination α of the first image IM1 based on the first read data DA1, and may perform an inclination correction of the first image IM1 based on the inclination α. In the second cutting out process, the control section 40 may calculate the inclination α of the second image IM2 based on the second read data DA2, and may perform the

inclination correction of the second image IM2 based on the inclination α.

In this case, since the inclination α of the image IM0 included in the outputted image is corrected, the outputted image can be made easier to view, and the convenience of the user can be improved.

### Third aspect

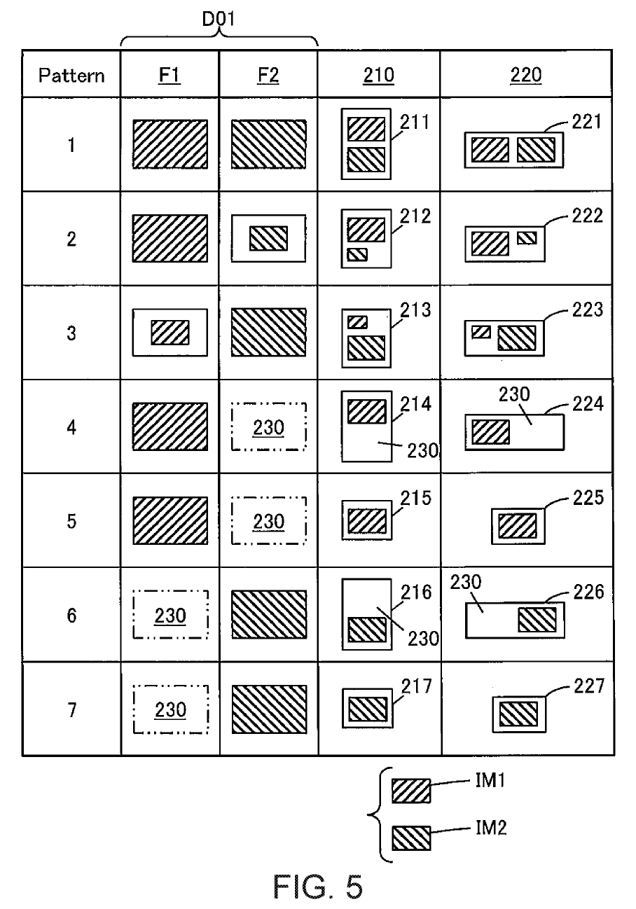

As illustrated in FIGS. 5, 15 and the like, in the size determination process, the control section 40 may determine the size, in a second direction D2 that intersects a first direction D1 in which the first image IM1 and the second image IM2 are arranged, of the composite image IM5 to be a size obtained by adding the margin B0 to the larger one of the first image IM1 and the second image IM2. In the composite image output process, the control section 40 may generate the composite image IM5 by arranging the first image IM1 and the second image IM2 in the first direction D1 with a space therebetween.

In this case, even when the first image and the second image have different sizes, the output image can be easily viewed.

### Fourth aspect

As illustrated in FIG. 5 and the like, in the composite image output process, the control section 40 may generate the composite image IM5 in which a size ratio between the first image IM1 and the second image IM2 is maintained, even if the first image IM1 and the second image IM2 have different sizes.

In this case, the larger one of the first image IM1 and the second image IM2 is relatively large in the outputted image and, therefore, the outputted image can be made even easier to view, and the convenience of the user can be improved.

### Fifth aspect

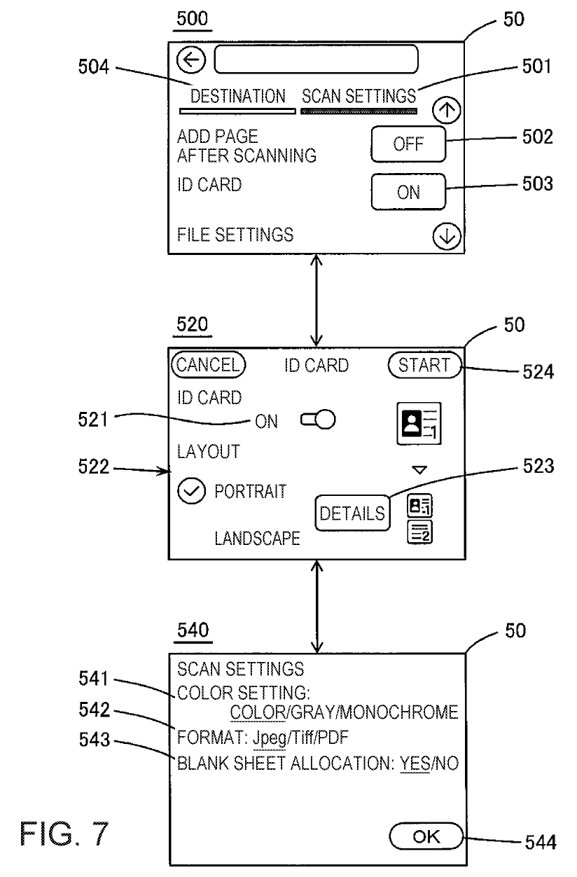

As illustrated in FIG. 7, when one of the first image IM1 and the second image IM2 is a blank sheet 230, the control section 40 may be able to receive a blank sheet allocation setting as to whether or not to include the blank sheet 230 in the composite image IM5. As illustrated in FIGS. 12 to 15, when the blank sheet allocation setting indicates that the blank sheet 230 is to be included in the composite image IM5 and one of the first image IM1 and the second image IM2 is the blank sheet 230, then in the size determination process, the control section 40 may determine the size of the composite image IM5 including the blank sheet 230. When the blank sheet allocation setting indicates that the blank sheet 230 is not to be included in the composite image IM5 and one of the first image IM1 and the second image IM2 is the blank sheet 230, then in the size determination process, the control section 40 may determine the size of the composite image IM5 without including the blank sheet 230.

When the first image IM1 or the second image IM2 is the blank sheet 230, if the setting is such that the blank sheet 230 is to be included in the composite image IM5, then an outputted image in which the blank sheet 230 is allocated is obtained, and if the setting is such that the blank sheet 230 is not to be included in the composite image IM5, an outputted image in which the blank sheet 230 is not included is obtained. Therefore, the above aspect can improve the convenience of the user.

### Sixth aspect

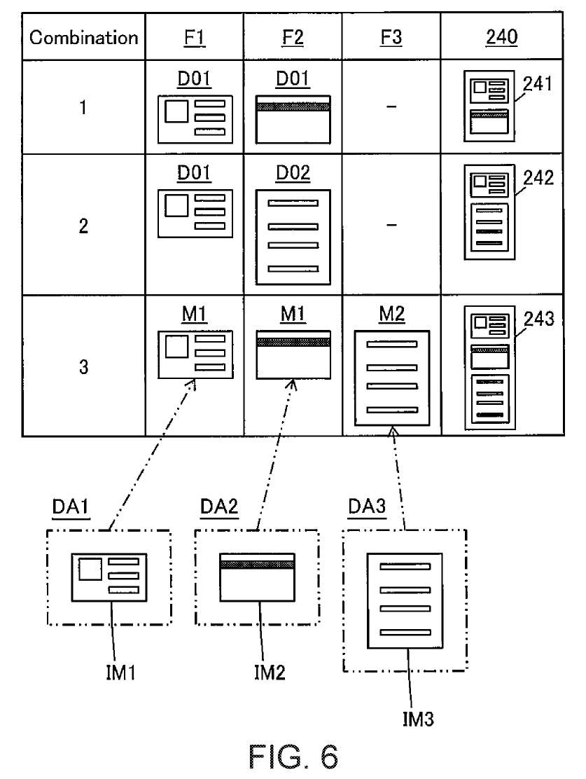

As illustrated in combination 2 of FIG. 6, the document D0 may include an ID card D01 having the first surface F1 and a medium D02 that is different from the ID card D01 and that has the second surface F2. In the composite image output process, the control section 40 may output the composite image IM5 including the first image IM1 derived from the ID card D01 and the second image IM2 derived from the medium D02.

The image reading device 1 described above can read the ID card D01 and the different medium D02 and output them as the composite image IM5, and thus can improve the convenience of the user.

### Seventh aspect

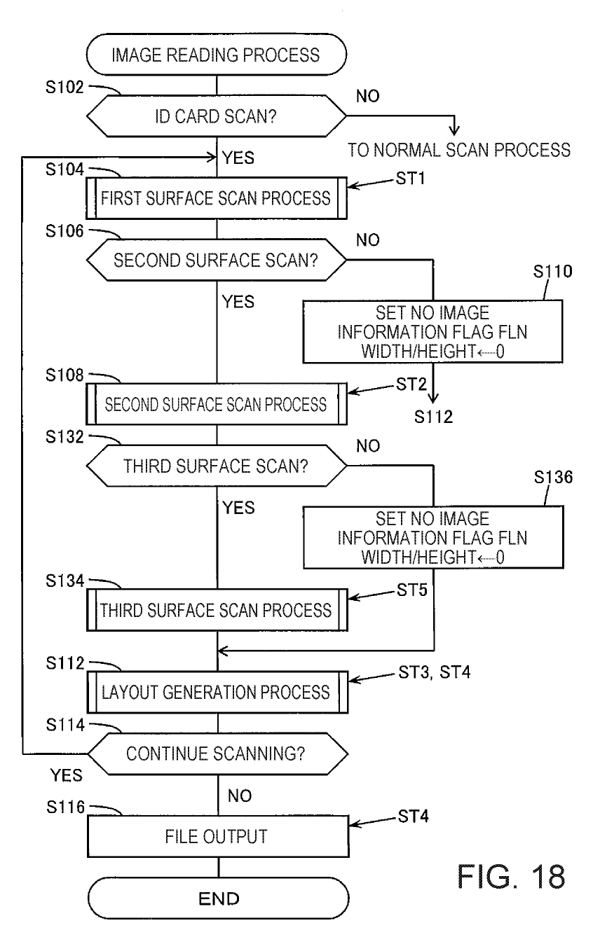

As illustrated in combination 3 in FIG. 6, the document D0 may include a first medium M1 having the first surface F1 and the second surface F2, which is opposite to the first surface F1, and a second medium M2 that is different from the first medium M1 and that has a third surface F3. The read data DA0 may include third read data DA3 generated by reading the third surface F3. As illustrated in FIG. 18, the control section 40 may, based on the third read data DA3, perform a third cutting out process (for example, a third surface scan process of step S134) of extracting the third image IM3 corresponding to the third surface F3 from a background BG0. In the size determination process, the control section 40 may determine the size of the composite image IM5 including the first image IM1, the second image IM2, and the third image IM3 including the margin B0, based on the size of the first image IM1, the size of the second image IM2, and the size of the third image IM3. In the composite image output process, the control section 40 may generate the composite image IM5 by allocating the first image IM1, the second image IM2, and the third image IM3 within the range of the determined size.

The image reading device 1 described above can read both surfaces of the first medium M1 and the third surface F3 of the second medium M2 and output them as the composite image IM5, and thus can improve the convenience of the user.

Of course, the document D0 may include a fourth and subsequent surfaces, and the composite image IM5 may include fourth and subsequent images. These additional remarks also apply to the following aspects.

### Eighth aspect

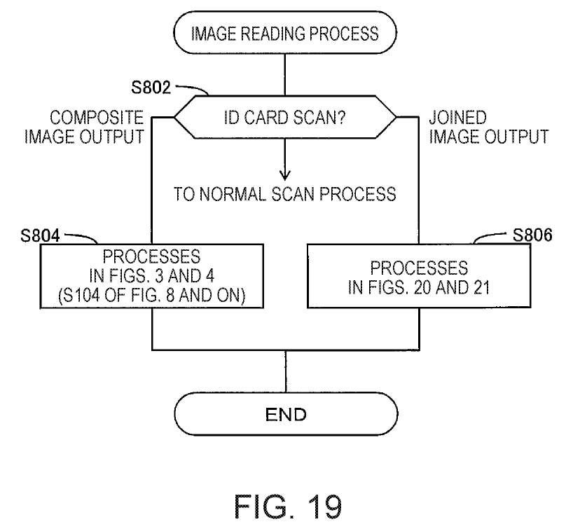

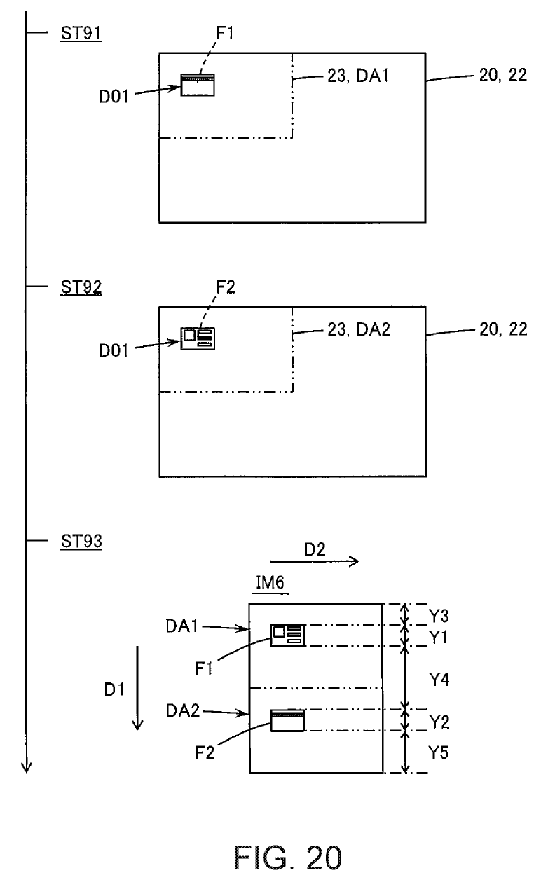

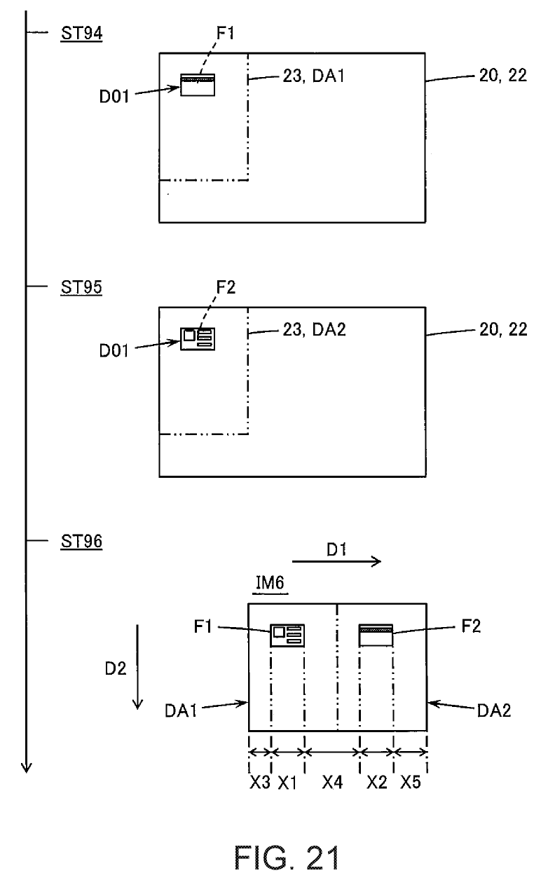

As illustrated in FIG. 19, the control section 40 may be capable of receiving an output setting as to whether or not to output the composite image IM5. When the output setting indicates that the composite image IM5 is to be output, the first read data DA1 and the second read data DA2 may have a first size (for example, A3 size), and the control section 40 may perform the first cutting out process, the second cutting out process, the size determination process, and the composite image output process, as illustrated in FIGS. 3, 4, and the like. When the output setting indicates that the composite image IM5 is not to be outputted, the first read data DA1 and the second read data DA2 may have a second size (for example, A5 size) that is smaller than the first size and, as illustrated in FIGS. 20 and 21, the control section 40 may generate a joined image IM6 by connecting the first read data DA1 and the second read data DA2, and may output the joined image IM6.

In the above case, it is possible to select whether to output the composite image IM5 in which the first image IM1 and the second image IM2 are allocated within the range of the determined size or to output a joined image IM6 in which the read data DA0 of the first surface F1 and the read data DA0 of the second surface F2 are connected. Therefore, the above aspect can improve the convenience of the user.

### Ninth aspect

As illustrated in FIGS. 3 and 4, the margin B0 may include a first margin B1 for the first image IM1 and a second margin B2 for the second image IM2. The control section 40 may be capable of receiving a size of the first margin B1 and a size of the second margin B2. In the size determination process, the control section 40 may determine the size of the composite image IM5 including the first image IM1 aligned with the first margin B1 and the second image IM2 aligned with the second margin B2. In the composite image output process, the control section 40 may generate the composite image IM5 by allocating the first image IM1 aligned with the first margin B1 and allocating the second image IM2 aligned with the second margin B2.

In this case, the size of the first margin B1 for the first image IM1 and the size of the second margin B2 for the second image IM2 can be set separately and, therefore, the outputted image can be made even easier to view, and convenience of the user can be improved.

### Tenth aspect

An image reading method according to an aspect is an image reading method in which a document D0 having a first surface F1 and a second surface F2 is read by the reading section 30, and a process is performed on the read data DA0 generated by the reading section 30, and includes the following processes.

(b1) A first cutting out step ST1 of, based on the first read data DA1, extracting a first image IM1 corresponding to the first surface F1 from a background BG0 (for example, step S104 in FIG. 8 and step S204 in FIG. 10).

(b2) A second cutting out step ST2 of, based on the second read data DA2, extracting a second image IM2 corresponding to the second surface F2 from the background BG0 (for example, step S108 in FIG. 8 and step S204 in FIG. 10).

(b3) A size determination step ST3 of, based on the size of the first image IM1 and the size of the second image IM2, determining a size of a composite image IM5 including the first image IM1 and the second image IM2 including a predetermined margin B0 (for example, the two image allocation process in FIG. 15).

(b4) A composite image output step ST4 of generating the composite image IM5 by allocating the first image IM1 and the second image IM2 within the range of the determined size and outputting the composite image IM5 (for example, step S112 and step S116 in FIG. 8, step S308 in FIG. 12, and the processes in FIGS. 14 to 16).

The above aspect can provide an image reading method capable of making an output image obtained by reading a document having a first surface and a second surface easy to view.

Further, the above-described aspects are applicable to an image reading system including the above-described image reading device, a control method of the above-described image reading device, a control method of the above-described image reading system, a control program of the above-described image reading device, a control program of the above-described image reading system, a computer-readable non-transitory medium in which any of the above-described control programs is stored, and the like. The image reading device described above may be configured by a plurality of distributed portions.

### 2. Specific example of image reading device

FIG. 1 schematically illustrates the structure of the image reading device 1.

The image reading device 1 illustrated in FIG. 1 includes a main body 2 having a flatbed document base 20 on the upper surface thereof, and an upper cover 3 having an ADF function. The main body 2 includes a reading section 30, a control section 40, an upper cover sensor 21 that detects whether the upper cover 3 is closed, and the like. When the document D0 is a hard ID card D01, the ID card D01 is directly placed on the document base 20. The upper cover 3 includes a document support section 10 that supports the document D0 to be fed to the reading section 30, a feed section 15 that feeds the document D0 from the document support section 10 to the reading section 30, a discharge tray 19, and the like. The document support section 10 is provided with a document detection sensor 11 that detects whether or not the document D0 has been placed there.

The reading section 30 includes a movement unit 31 that is movable along a horizontal guide rail 33 extending in the direction of the double-headed arrow in FIG. 1. The movement unit 31 includes a line sensor 32 oriented in a horizontal direction orthogonal to the guide rail 33, a light source (not illustrated), a light guide (not illustrated), a lens (not illustrated), and the like, and is moved along the guide rail 33 by a driving section (not illustrated). In a state where the document D0 is placed on the document base 20, the line sensor 32 reads an image of the document D0 while moving in a direction along the guide rail 33. The reading section 30 generates two dimensional read data DA0 based on the output of the line sensor 32 at each position in the direction along the guide rail 33, and outputs the two dimensional read data DA0 to the control section 40. Note that a solid-state imaging element such as a complementary metal-oxide semiconductor (CMOS) image sensor or a charge coupled device (CCD) line sensor can be used as the line sensor 32.

The feed section 15 includes a feed roller 16, a discharge roller 17, a transport path 18, and the like. The document D0 placed on the document support section 10 is fed to the transport path 18 by rotation of the feed roller 16, and is discharged from the transport path 18 to the discharge tray 19 by rotation of the discharge roller 17. At this time, the movement unit 31 is at a position where the line sensor 32 faces the transport path 18, and the reading section 30 generates the two dimensional read data DA0 based on the output of the line sensor 32 at each timing, and outputs the two dimensional read data DA0 to the control section 40.

As described above, the reading section 30 can execute the ADF scan for reading the document D0 in a state of being fed by the feed section 15 and the flatbed scan for reading the document D0 placed on the document base 20. Of course, the image reading device 1 may not have the ADF scan function.

FIG. 2 is a block diagram schematically illustrating configuration of an image reading system SY1 including the image reading device 1.

The control section 40 of the image reading device 1 illustrated in FIG. 2 includes a central processing section (CPU), a read only memory (ROM), a random access memory (RAM), an interface (I/F), and an application specific integrated circuit (ASIC). The above-described elements are electrically connected to each other and can input and output information to and from each other. The CPU performs various processes by executing programs stored in the ROM. The RAM is allocated with a memory necessary for executing the programs, and stores the read data DA0 generated by the reading section 30. The ASIC is an integrated circuit for a scanner device, and operates according to a register set or a trigger from the CPU. The control section 40 may be referred to as a processor, and may include a CPU instead of the ASIC described above, or may include an ASIC instead of the CPU described above. Of course, the control section 40 may include a plurality of CPUs. The ROM and the RAM are semiconductor memories. The I/F of the image reading device 1 is connected to an I/F 117 of a host device 100. The feed section 15, the reading section 30, the document detection sensor 11, the upper cover sensor 21, a display section 50, an operation section 51, a printing section 55, and the like are connected to the ASIC. Examples of the display section 50 include a liquid crystal display, a light emitting diode, and the like. Examples of the operation section 51 include a touch panel on the display section 50 or on the housing, a hard key, and the like. Examples of the printing section 55 include an ink jet printer or an electrophotographic printer such as a laser printer. Of course, the image reading device 1 may not include the printing section 55.

The control section 110 of the host device 100 illustrated in FIG. 2 includes a CPU 111, a ROM 112, a RAM 113, a storage section 114, an input section 115, a display section 116, and the I/F 117. The above-described elements (111 to 117) are electrically connected to each other and can input and output information to and from each other. Examples of the host device 100 include a personal computer, a tablet terminal, and a mobile phone such as a smartphone.

The image reading device 1 of the present example reads an ID card D01 having a first surface F1 on the front side and a second surface F21 on the back side, and generates a composite image IM5 including a first image IM1 corresponding to the first surface F1, a second image IM2 corresponding to the second surface F2, and a predetermined margin B0. When host output is selected as the outputting method of the composite image IM5, the image reading device 1 transmits the composite image IM5 to the host device 100. When the host device 100 receives the composite image IM5, the host device 100 can display the composite image IM5 on the display section 116, for example. Since the margin B0 is narrower than both images (IM1, IM2), the first image IM1 on the front side and the second image IM2 on the back side are easily viewed together. When ID card copy is selected as the method of outputting the composite image IM5, the image reading device 1 uses the printing section 55 to print the composite image IM5 on a single sheet printing paper. The print setting may be equal magnification printing for performing printing in the size of the composite image IM5 as is, or may be variable magnification printing for varying the magnification of the composite image IM5 according to the size of the printing sheet, such as enlargement printing for enlarging the composite image IM5 to match the size of the printing sheet.

First, an example of ID card scanning by the read data joining method will be described with reference to FIGS. 20 and 21. FIG. 20 illustrates an example of generating a joined image IM6 by vertically connecting the first read data DA1 of the front side and the second read data DA2 of the back side in a portrait layout. FIG. 21 illustrates an example of generating a joined image IM6 by connecting the first read data DA1 of the front side and the second read data DA2 of the back side in the landscape layout.

The ID card scan of the read data joining method is performed by a flatbed scan. In both reading of the first surface F1 of the ID card and reading of the second surface F2 of the ID card, a placement range 23 narrower than the reading range 22 of the document base 20 is set. For example, when the reading range 22 is A3 size and the joined image IM6 is to be printed in A4 size, the placement range 23 is set to A5 size. Normally, the upper left corner of the placement range 23 is aligned with the upper left corner of the reading range 22.

When the image reading device performs an ID card scan of the portrait layout illustrated in FIG. 20, the image reading device performs the following processes in order.

(Process 1) A process of receiving selection of an ID card scan menu.

At this time, the user sets the front side (first surface F1) of the ID card in a placement range 23 of, for example, A5 landscape, that is set for the document base 20 and performs an operation of causing the image reading device to read the placement range 23.

(Process 2) A process of reading the placement range 23 with the above-described operation as a trigger and generating first read data DA1 of, for example, A5 landscape (process ST91).

Thereafter, the user sets the back side (second surface F2) of the ID card in the placement range 23 of, for example, A5 landscape, and performs an operation of causing the image reading device to read the placement range 23.

(Process 3) A process of reading the placement range 23 with the above-described operation as a trigger and generating second read data DA2 of, for example, A5 landscape (process ST92).

(Process 4) A process of generating a joined image IM6 of, for example, A4 portrait, by connecting the second read data DA2 below the first read data DA1 (process ST93).

(Process 5) A process of outputting the joined image IM6 of, for example, A4 portrait, to a predetermined destination. For example, a process of printing the joined image IM6 on a printing sheet of A4 portrait. FIG. 20 illustrates a joined image IM6 in which a first surface F1 and a second surface F2 are arranged in the Y direction as the first direction D1. The second direction D2 illustrated in FIG. 20 is the X direction, which is orthogonal to the Y direction.

When the image reading device performs the ID card scan in the landscape layout illustrated in FIG. 21, the image reading device performs the following processes in order.

(Process 1) A process of receiving selection of an ID card scan menu.

At this time, the user sets the front side (first surface F1) of the ID card in the placement range 23 of, for example, A5 portrait, set on the document base 20, and performs an operation of causing the image reading device to read the placement range 23.

(Process 2) A process of reading the placement range 23 with the above-described operation as a trigger and generating first read data DA1 of, for example, A5 portrait (process ST94).

Thereafter, the user sets the back side (second surface F2) of the ID card in the placement range 23 of, for example, A5 portrait, and performs an operation of causing the image reading device to read the placement range 23.

(Process 3) A process of reading the placement range 23 with the above-described operation as a trigger and generating second read data DA2 of, for example, A5 portrait (process ST95).

(Process 4) A process of generating a joined image IM6 of, for example, A4 landscape, by connecting the second read data DA2 to the right of the first read data DA1 (process ST96).

(Process 5) A process of outputting the joined image IM6 of, for example, A4 landscape, to a predetermined destination. For example, a process of printing the joined image IM6 on a A4 landscape printing sheet. FIG. 21 illustrates a joined image IM6 in which a first surface F1 and a second surface F2 are arranged in the X direction as the first direction D1. The second direction D2 illustrated in FIG. 21 is the Y direction, which is orthogonal to the X direction.

The ID card scan of the read data joining method has the following issues.

First, since the joined image IM6 has a fixed size, such as A4 size, when the ID card is considerably smaller than the placement range 23, a wide blank space, such as a gap between the first surface F1 on the front side and the second surface F2 on the back side, is generated in the joined image IM6. FIG. 20 illustrates that, with respect to the Y direction, the distance Y4 between the first surface F1 and the second surface F2 is longer than the heights Y1 and Y2 of the ID card, and the total distance Y3 + Y5 of the margins at the ends is longer than the heights Y1 and Y2 of the ID card. FIG. 21 illustrates that, with respect to the X direction, the distance X4 between the first surface F1 and the second surface F2 is longer than the widths X1 and X2 of the ID card, and the total distance X3 + X5 of the margins at the ends is longer than the widths X1 and X2 of the ID card. Since a wide blank space is present in the joined image IM6, it is difficult to see necessary portions (the first surface F1 and the second surface F2).

When the ID card is placed on the document base 20 in contact with the end of the placement range 23, the image at the end of the ID card is cut off. Therefore, it is necessary to place the ID card on the document base 20 with a small space, for example, a 5 mm, opened up from the end of the placement range 23.

Further, when the ID card is placed on the document base 20 in an inclined manner, the images of the first surface F1 and the second surface F2 included in the joined image IM6 are inclined.

Further, since the boundary of the placement range 23 is not clearly indicated on the document base 20, if the ID card protrudes from the placement range 23, the image of the ID card will be cut. Of course, when the document D0 is larger than the placement range 23, the entire surface of the document D0 cannot be read.

In the present example, as illustrated in FIGS. 3 and 4, the document D0 such as the ID card D01 can be placed entirely within the reading range 22 of the document base 20, and the first image IM1 corresponding to the first surface F1 and the second image IM2 corresponding to the second surface F2 are extracted from the background BG0. Accordingly, at least a portion of the above-described issues is solved.

FIGS. 3 and 4 schematically illustrate an example of ID card scanning of the cut out image composing method. FIG. 3 illustrates an example in which, in the portrait layout, a first image IM1 corresponding to the first surface F1 is cut out from the first read data DA1 on the front side, a second image IM2 corresponding to the second surface F2 is cut out from the second read data DA2 on the back side, and a composite image IM5 is generated. FIG. 4 illustrates an example in which, in the landscape layout, a first image IM1 corresponding to the first surface F1 is cut out from the first read data DA1 of the front side, a second image IM2 corresponding to the second surface F2 is cut out from the second read data DA2 of the back side, and a composite image IM5 is generated. Each composite image IM5 includes the first image IM1 and the second image IM2 including a relatively narrow margin B0. Note that the read data DA0 illustrated in FIGS. 3 and 4 collectively refers to the first read data DA1 and the second read data DA2, and the image IM0 illustrated in FIGS. 3 and 4 collectively refers to the first image IM1 and the second image IM2. In FIG. 3, the margin B0 above the first image IM1 is also indicated as a first margin B1 for the first image IM1, and the margin B0 below the second image IM2 is also illustrated as a second margin B2 for the second image IM2. In FIG. 4, the margin B0 on the left of the first image IM1 is also illustrated as the first margin B1 for the first image IM1, and the margin B0 on the right of the second image IM2 is also illustrated as the second margin B2 for the second image IM2.

The image reading device 1 performs the following processes when performing the ID card scan of the portrait layout illustrated in FIG. 3.

(Process 1) A process of receiving selection of an ID card scan menu.

At this time, the user sets the front side (first surface F1) of the ID card D01 somewhere in the reading range 22 of the document base 20, and performs an operation of causing the image reading device 1 to read the reading range 22.

(Process 2) A process of reading the reading range 22 with the above-described operation as a trigger and generating first read data DA1 of, for example, A3 landscape (process ST11).

Thereafter, the user sets the back side (second surface F21) of the ID card D01 somewhere in the reading range 22 of the document base 20, and performs an operation of causing the image reading device 1 to read the reading range 22.

(Process 3) A process of reading the reading range 22 with the above-described operation as a trigger and generating second read data DA2 of, for example, A3 landscape (process ST12).

(Process 4) A first cutting out process of extracting a first image IM1 corresponding to the first surface F1 from the background BG0 based on the first read data DA1. Process 4 may be performed after process 2, and may be performed before process 3.

(Process 5) A second cutting out process of extracting a second image IM2 corresponding to the second surface F2 from the background BG0 based on the second read data DA2. Process 5 may be performed after process 2, and may be performed before process 4 or process 3.

(Process 6) A size determination process of determining, based on the size of the first image IM1 and the size of the second image IM2, a size of a composite image IM5 that includes the first image IM1 and the second image IM2 including the predetermined margin B0.

(Process 7) A process of generating a composite image IM5 by allocating the first image IM1 and the second image IM2 within the determined size range (step ST13).

(Process 8) A process of outputting the composite image IM5 to a predetermined destination. For example, a process of printing the composite image IM5 on a printing sheet. FIG. 3 illustrates a composite image IM5 in which a first surface F1 and a second surface F2 are arranged in the Y direction as the first direction D1. The second direction D2 illustrated in FIG. 3 is the X direction, which is orthogonal to the Y direction, and intersects the first direction D1.

The image reading device 1 performs the following processes when performing the ID card scan of the landscape layout illustrated in FIG. 4.

(Process 1) A process of receiving selection of an ID card scan menu.

At this time, the user sets the front side (first surface F1) of the ID card D01 somewhere in the reading range 22 of the document base 20, and performs an operation of causing the image reading device 1 to read the reading range 22.

(Process 2) A process of reading the reading range 22 with the above-described operation as a trigger and generating first read data DA1 of, for example, A3 landscape (step ST14).

Thereafter, the user sets the back side (second surface F21) of the ID card D01 somewhere in the reading range 22 of the document base 20, and performs an operation of causing the image reading device 1 to read the reading range 22.

(Process 3) A process of reading the reading range 22 with the above-described operation as a trigger and generating second read data DA2 of, for example, A3 landscape (step ST15).

(Process 4) A first cutting out process of extracting a first image IM1 corresponding to the first surface F1 from the background BG0 based on the first read data DA1. Process 4 may be performed after process 2, and may be performed before process 3.

(Process 5) A second cutting out process of extracting a second image IM2 corresponding to the second surface F2 from the background BG0 based on the second read data DA2. Process 5 may be performed after process 2, and may be performed before process 4 or process 3.

(Process 6) A size determination process of determining, based on the size of the first image IM1 and the size of the second image IM2, a size of a composite image IM5 that includes the first image IM1 and the second image IM2 including the predetermined margin B0.

(Process 7) A process of generating a composite image IM5 by allocating the first image IM1 and the second image IM2 within the range of the determined size (step ST16).

(Process 8) A process of outputting the composite image IM5 to a predetermined destination. For example, a process of printing the composite image IM5 on a printing sheet. FIG. 4 illustrates a composite image IM5 in which the first surface F1 and the second surface F2 are arranged in the X direction as the first direction D1. The second direction D2 illustrated in FIG. 4 is the Y direction, which is orthogonal to the X direction, and intersects the first direction D1.

FIGS. 3 and 4 illustrate that the margin B0 is smaller than both images (IM1 and IM2). FIG. 3 illustrates that the distance Y4 between the first image IM1 and the second image IM2 is shorter than the height Y1 and Y2 of the ID card in the Y direction, and the total distance Y3 + Y5 of the margins at the ends is shorter than the heights Y1 and Y2 of the ID card in the Y direction. FIG. 4 illustrates that the distance X4 between the first image IM1 and the second image IM2 is shorter than the widths X1 and X2 of the ID card in the X direction, and the total length X3 + X5 of the margins at the ends is shorter than the widths X1 and X2 of the ID card in the X direction. Since the composite image IM5 has little blank space, necessary portions (the first image IM1 and the second image IM2) are easily viewed.

Since the ID card D01 may be placed anywhere in the reading range 22, the images (IM1, IM2) of the ID card D01 are not cut off. As long as the document D0 is smaller than the reading range 22, a document D0 that is wider than the placement range 23 illustrated in FIGS. 20 and 21 can be read.

As illustrated in FIG. 5, the image reading device 1 of the present example allocates the images (IM1, IM2) in an optimal size according to the first image IM1 obtained from the first surface F1 and the second image IM2 obtained from the second surface F2. FIG. 5 schematically illustrates allocation examples of the first image IM1 and the second image IM2. Hereinafter, as the composite image IM5 generated from the images (IM1, IM2) of the patterns 1 to 7 illustrated in FIG. 5, composite images 211 to 217 in a portrait layout 210 and composite images 221 to 227 in a landscape layout 220 will be described. The first image IM1 and the second image IM2 are allocated vertically in the portrait layout 210, and the first image IM1 and the second image IM2 are allocated horizontally in the landscape layout 220.

Pattern 1 illustrates an example in which the first image IM1 and the second image IM2 have the same size. In this case, the widths of both images (IM1, IM2) are the same in the composite image 211 of the portrait layout 210, and the heights of both images (IM1, IM2) are the same in the composite image 221 of the landscape layout 220.

Pattern 2 illustrates an example in which the second image IM2 is smaller than the first image IM1. For example, when there is a wide margin around the portion of the second surface F2 that becomes the second image IM2, the second image IM2 may be smaller than the first image IM1. In the case of the pattern 2, the width of the composite image 222 is determined based on the width of the first image IM1 in the portrait layout 210, and the height of the composite image 212 is determined based on the height of the first image IM1 in the landscape layout 220.

Pattern 3 illustrates an example in which the second image IM2 is larger than the first image IM1. For example, when there is a wide margin around a portion of the first surface F1 that is to be the first image IM1, the second image IM2 may be larger than the first image IM1. In the case of the pattern 3, the width of the composite image 223 is determined based on the width of the second image IM2 in the portrait layout 210, and the height of the composite image 213 is determined based on the height of the second image IM2 in the landscape layout 220.

Pattern 4 illustrates an example in which the second surface F2 is a blank sheet 230 and the blank sheet 230 is allocated. In this case, it can be said that the second image IM2 is a blank sheet 230. However, the blank sheet 230 as the second image IM2 may be obtained by reading the second surface F2, or the blank sheet 230 as the second image IM2 may be obtained according to a setting that sets the second surface F2 to be the blank sheet 230. In the case of the pattern 4, the blank sheet 230 is arranged below the first image IM1 in the composite image 214 of the portrait layout 210, and the blank sheet 230 is arranged to the right of the first image IM1 in the composite image 224 of the landscape layout 220.

Pattern 5 illustrates an example in which the second surface F2 is a blank sheet 230 and the blank sheet 230 is allocated. In this case, the second image IM2 is also considered to be the blank sheet 230. Here, the blank sheet 230 as the second image IM2 may be obtained by reading the second surface F2, or the blank sheet 230 as the second image IM2 may be obtained according to a setting that sets the second surface F2 to be the blank sheet 230. In the case of the pattern 5, only the first image IM1, together with a narrow margin B0, is allocated in both the composite image 215 of the portrait layout 210 and the composite image 225 of the landscape layout 220.

Pattern 6 illustrates an example in which the first surface F1 is a blank sheet 230 and the blank sheet 230 is allocated. In this case, the first image IM1 is the blank sheet 230. However, the blank sheet 230 as the first image IM1 may be obtained by reading the first surface F1, or the blank sheet 230 as the first image IM1 may be obtained according to a setting that sets the first surface F1 to be the blank sheet 230. In the case of the pattern 6, the blank sheet 230 is arranged on the second image IM2 in the composite image 216 of the portrait layout 210, and the blank sheet 230 is arranged on the left of the second image IM2 in the composite image 226 of the landscape layout 220.

Pattern 7 illustrates an example in which the first surface F1 is a blank sheet 230 and the blank sheet 230 is not allocated. In this case, the first image IM1 is also the blank sheet 230. Here, the blank sheet 230 as the first image IM1 may be obtained by reading the first surface F1, or the blank sheet 230 as the first image IM1 may be obtained according to a setting that sets the first surface F1 to be the blank sheet 230. In the case of pattern 7, only the second image IM2, together with a narrow margin B0, is allocated in both the composite image 217 of the portrait layout 210 and the composite image 227 of the landscape layout 220.

As illustrated in FIG. 6, the images to be incorporated in the composite image IM5 can be obtained by reading various surfaces included in documents D0. FIG. 6 schematically illustrates an example of a combination of reading surfaces. Hereinafter, as the composite image IM5 generated from combinations 1 to 3 illustrated in FIG. 6, composite images 241 to 243 in the portrait layout 240 will be described.

As described above, the combination 1 illustrates an example in which the front side of the ID card D01 is read as the first surface F1, the back side of the ID card D01 is read as the second surface F2, and the obtained first image IM1 and second image IM2 are allocated to the portrait layout 240. The generated composite image 241 includes a first image IM1 derived from the front side of the ID card D01 and a second image IM2 derived from the back side of the ID card D01, together with a predetermined margin B0. The second image IM2 is below the first image IM1. Although not shown, the first image IM1 and the second image IM2 may be allocated in a landscape layout.

The document D0 to be read may include an ID card D01 having the first surface F1 and a medium D02 that is different from the ID card D01 and that has the second surface F2. Combination 2 illustrates an example in which one side of the ID card D01 is read as the first surface F1, one side of the medium D02, which is different from than the ID card D01, is read as the second surface F2, and the obtained first image IM1 and second image IM2 are allocated to the portrait layout 240. The generated composite image 242 includes a predetermined margin B0 in addition to a first image IM1 derived from one side of the ID card D01 and a second image IM2 derived from one side of the medium D02. Here, the first image IM1 and the second image IM2 may be allocated in the landscape layout.

The document D0 to be read may include a first medium M1 having a first surface F1 and a second surface F2, which is opposite to the first surface F1, and a second medium M2 that is different from the first medium M1 and that has a third surface F3. The first medium M1 may be an ID card D01. Combination 3 illustrates an example in which the front side of the first medium M1 is read as the first surface F1, the back side of the first medium M1 is read as the second surface F2, and one side of the second medium M2 is read as the third surface F3, and the obtained first image IM1, second image IM2, and third image IM3 are allocated to the portrait layout 240. In the case of the combination 3, the reading section 30 generates the third read data DA3 by reading the third surface F3. The read data DA0 can be said to include first read data DA1, second read data DA2, and third read data DA3. The control section 40 performs, based on the third read data DA3, a third cutting out process of extracting a third image IM3 corresponding to the third surface F3 from the background BG0. The image IM0 can be said to include a first image IM1, a second image IM2, and a third image IM3. The generated composite image 243 includes, together with a predetermined margin B0, a first image IM1 derived from the first surface F1 of the first medium M1, a second image IM2 derived from the second surface F2 of the first medium M1, and a third image IM3 derived from one side of the second medium M2. These images (IM1, IM2, IM3) may be allocated in a landscape layout.

(3) Specific example of processes performed by image reading device

The image reading device 1 illustrated in FIGS. 1 and 2 is capable of receiving the setting of the ID card scan while displaying the UI screen (500, 520, 540) illustrated in FIG. 7 on the display section 50. The control section 40 performs control to display the UI screen on the display section 50.

First, the control section 40 causes the display section 50 to display a main screen 500 illustrated in the upper part of FIG. 7. The main screen 500 includes a scan setting tab 501, a page addition setting region 502, an ID card scan setting region 503, a destination tab 504, and the like. The user can operate these regions (501 to 504) by touching a touch panel included in the operation section 51. The main screen 500 illustrated in FIG. 7 illustrates a state where the scan setting tab 501 is selected. In this state, the control section 40 receives the setting of the ID card scan via the operation section 51. When the operation section 51 receives an operation on the page addition setting region 502, the control section 40 internally sets whether or not to perform continuous scanning. Continuous scanning of the ID card D01 means that the front and back sides of a plurality of ID cards D01 are continuously read. Scanning of the ID card D01 that is continuous scanning means that the front and back of a single ID card D01 are read.

When the operation section 51 receives an operation on the ID card scan setting region 503, the control section 40 causes the display section 50 to display an ID card scan setting screen 520 illustrated in the middle part of FIG. 7. The ID card scan setting screen 520 includes a switch 521 for switching whether or not to perform ID card scanning, a layout selection region 522, a details setting region 523, an OK button 524, and the like. The user can operate these regions (521 to 524) by touching a touch panel included in the operation section 51. When the operation section 51 receives an operation on the switch 521, the control section 40 internally sets whether or not to perform ID card scanning. In the setting for performing the ID card scan, when the operation section 51 receives an operation on the layout selection region 522, the control section 40 internally sets whether the composite image IM5 is to be set to the portrait layout 210 or the landscape layout 220 (see FIG. 5).

When the operation section 51 receives an operation on the details setting region 523, the control section 40 causes the display section 50 to display a details setting screen 540 illustrated in the lower part of FIG. 7. The details setting screen 540 includes a color setting region 541, a format setting region 542, a blank sheet allocation setting region 543, an OK button 544, and the like. The user can operate these regions (541 to 544) by touching a touch panel included in the operation section 51. When the operation section 51 receives an operation on the color setting region 541, the control section 40 internally sets bit information indicating whether the composite image IM5 is to be color, gray, or monochrome, for example. For example, color means that a single pixel has information of 8 bits of R (red), 8 bits of G (green), and 8 bits of B (blue), gray means that a single pixel has information of 8 bits of gray, and monochrome means that a single pixel has information of 1 bit of monochrome. When the operation section 51 receives an operation in the format setting region 542, the control section 40 internally sets, for example, whether the file format of the composite image IM5 is set to Jpeg format, Tiff format, or PDF format. When the operation section 51 receives an operation on the blank sheet allocation setting region 543 in a case where one of the first image IM1 and the second image IM2 is the blank sheet 230, the control section 40 internally sets a blank sheet allocation setting of whether to allocate the blank sheet 230 as in patterns 4 and 6 illustrated in FIG. 5 or not to allocate the blank sheet 230 as in patterns 5 and 7 illustrated in FIG. 5. Therefore, when one of the first image IM1 and the second image IM2 is a blank sheet 230, the control section 40 can receive a blank sheet allocation setting as to whether or not to include the blank sheet 230 in the composite image IM5. When the operation section 51 receives the operation of the OK button 544, the control section 40 returns the display of the display section 50 to the ID card scan setting screen 520.

When the operation section 51 receives an operation on the OK button 524 of the ID card scan setting screen 520, the control section 40 returns the display of the display section 50 to the main screen 500. When the operation section 51 receives an operation on the destination tab 504 of the main screen 500, the control section 40 causes the display section 50 to display a destination setting screen (not illustrated), and receives a setting of an output destination for the composite image IM5 via the operation section 51. Examples of the output destination of the composite image IM5 include the host device 100, the printing section 55, an external storage device, an e-mail address, a facsimile transmission destination, and the internal storage section 114. The output destination may be an address of the storage section 114 of the host device 100, an address of an external storage device, an address of the internal storage section 114, or the like.

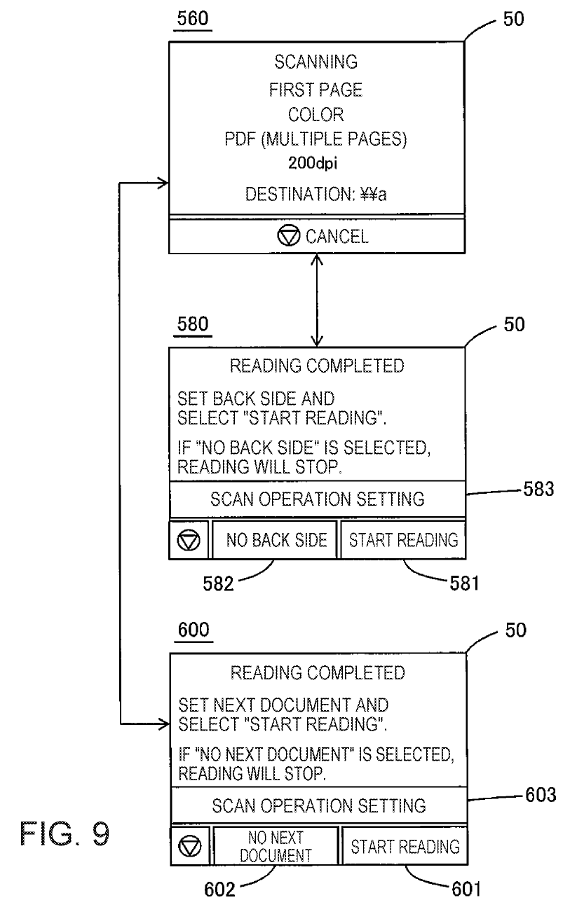

FIG. 8 schematically illustrates an image reading process performed by the control section 40. FIG. 9 schematically illustrates a display example of screens (560, 580, 600) displayed during the image reading process.

In FIG. 8, the first cutting out step ST1 is executed is executed, and the first cutting out process of extracting the first image IM1 from the background BG0 is performed, by the first surface scan process of step S104. The second cutting out step ST2 is executed, and the second cutting out process of extracting the second image IM2 from the background BG0 is performed, by a second surface scan process of step S108. By the layout generation process of step S112, the size determination step ST3 is executed and the size determination process of determining the size of the composite image IM5 is performed. The composite image output step ST4 is executed, and the composite image output process of generating and outputting the composite image IM5 is performed, by the layout generation process of step S112 and the file output process of step S116. Hereinafter, the description of "step" may be omitted, and the reference numeral of the step may be illustrated in parentheses.

When the operation section 51 receives an operation of a start button included in the operation section 51, the control section 40 starts the image reading process. First, the control section 40 advances the process to S104 when the setting according to the state of the switch 521 illustrated in FIG. 7 is ID card scan, and performs a "normal scan process" when the setting is not ID card scan (S102). “Normal scan process" means a scan process that is not an ID card scan, and may be a flatbed scan or an ADF scan.

In S104, the control section 40 causes the display section 50 to display a scanning display screen 560 illustrated in FIG. 9, and performs a first surface scan process for reading the first surface F1 of the ID card D01. The first surface scan process can be performed according to the flow illustrated in FIG. 10, for example. Note that the second surface scan process of S108 and the third surface scan process of S134 illustrated in FIG. 18 can also be performed according to the flow illustrated in FIG. 10. The scan process of steps S104, S108, and S134 will be described with reference to FIG. 10.

FIG. 10 schematically illustrates the scan process performed by the control section 40. FIG. 11 schematically illustrates the cutting out process performed in S204.

First, the control section 40 causes the reading section 30 to read the entire reading range 22 of the document base 20, and acquires the read data DA0 from the reading section 30 (S202). The reading section 30 performs flatbed scanning to read the entire reading range 22, and generates read data DA0. When the first surface F1 of the ID card D01 faces the document base 20, the first read data DA1 corresponding to the reading range 22 is generated by reading the first surface F1, and the control section 40 acquires the first read data DA1. When the second surface F2 of the ID card D01 faces the document base 20, the second read data DA2 corresponding to the reading range 22 is generated by reading the second surface F2, and the control section 40 acquires the second read data DA2. When the third surface F3 of the second medium M2 (see FIG. 6) faces the document base 20, the third read data DA3 corresponding to the reading range 22 is generated by reading the third surface F3 of the second medium M2, and the control section 40 acquires the third read data DA3.

Next, based on the read data DA0, the control section 40 detects an image IM0 corresponding to the document D0 from the read data DA0, corrects the inclination of the image IM0 as necessary, and extracts the image IM0 from the background BG0 (S204). FIG. 11 illustrates an example of a cutting out process involving inclination correction of the image IM0. Note that inclination correction may be omitted.

First, the control section 40 detects an edge E1 between the image IM0 and the background BG0 based on the read data DA0. The edge E1 can be detected by, for example, applying a known edge detection filter to the read data DA0. Next, the control section 40 specifies the positions of the vertices V1, V2, V3, and V4 of the quadrangle assumed as the image IM0 based on the orientation of the edge E1. Next, the control section 40 calculates the inclination of the line segment connecting the vertices V1 and V2, of the line segment connecting the vertices V2 and V3, of the line segment connecting the vertices V3 and V4, and of the line segment connecting the vertices V4 and V1, and calculates the inclination α of the image value by averaging the calculated inclinations. When the inclination α exceeds the threshold value, the control section 40 performs the inclination correction of the image IM0 section based on the inclination α. The upper part of FIG. 11 illustrates that the image IM0 included in the read data DA0 has an inclination α exceeding the threshold value. In this case, the control section 40 rotates the read data DA0 by an angle corresponding to the inclination α. The middle part of FIG. 11 illustrates the read data DA0 in which inclination correction of the image IM0 was performed. When the inclination α is equal to or less than the threshold value, the control section 40 may not perform inclination correction. Lastly, the control section 40 extracts the image IM0 from the background BG0 based on the read data DA0. The lower part of FIG. 11 illustrates the cut out image IM0.

As described above, in S104 illustrated in FIG. 8, based on the first read data DA1, the control section 40 performs the first cutting out process of extracting the first image IM1 corresponding to the first surface F1 from the background BG0. As necessary, the control section 40 calculates the inclination α of the first image IM1 based on the first read data DA1, and performs inclination correction of the first image IM1 based on the inclination α. In S108 illustrated in FIG. 8, the control section 40 performs a second cutting out process of extracting the second image IM2 corresponding to the second surface F2 from the background BG0 based on the second read data DA2. As necessary, the control section 40 calculates the inclination α of the second image IM2 based on the second read data DA2, and performs inclination correction of the second image IM2 based on the inclination α. Further, in S134 illustrated in FIG. 18, the control section 40 performs a third cutting out process of extracting a third image IM3 corresponding to the third surface F3 from the background BG0 based on the third read data DA3. As necessary, the control section 40 calculates the inclination α of the third image IM3 based on the third read data DA3, and performs inclination correction of the third image IM3 based on the inclination α.

By correcting the inclination of the images (IM1, IM2, IM3) incorporated into the composite image IM5, the composite image IM5 becomes more easily viewable.

In this example, after the cutting out process of S204 illustrated in FIG. 10, a process is performed on the assumption that the memory mounted on the image reading device 1 is limited. When the image reading device includes a hard disk drive, a large amount of image data can be stored in the hard disk drive. When an ID card scan in the size A4 is performed in 600dpi, approximately 52M byte is required for RGB data of the front side image, approximately 52M byte is required for RGB data of the back side image, and approximately 104M byte is required for the RGB data of the layout image in which the front and back are combined. Since RGB images of before and after processing are necessary for generating the layout image, a large amount of storage space, such as 208M byte, is required in total. However, when the image reading device 1 does not include a hard disk drive as in the case of a document scanner, the memory available for processing is limited, and it is not possible to perform ID card scanning with a large amount of data. Of course, mounting a hard disk drive is not cost-effective.

In this example, in the process after S206 illustrated in FIG. 10, the data size of the image IM0 is limited to an upper limit (for example, 4M bytes).

In S206, the control section 40 branches the process depending on whether or not the bit information set in the color setting region 541 illustrated in FIG. 7 indicates monochrome.

When the bit information indicates color or gray, the control section 40 performs a low compression process of compressing the cut-out image IM0 so as to have bit information of a low compression ratio in order to suppress the size of the image IM0 (S208). Examples of the low compression processes include Jpeg conversion with a low compression ratio. After the low compression process, the control section 40 determines whether or not the size of the image IM0 after the low compression process exceeds the upper limit (S210), and when the size exceeds the upper limit, the control section 40 performs a high compression process of compressing the cut-out image IM0 to bit information at a high compression ratio so that the size of the cut-out image LA is equal to or less than the upper limit (S212). Examples of the high compression process include Jpeg conversion with a high compression ratio. Of course, the compression ratio in the high compression process is higher than the compression ratio in the low compression process. Since characters are considered important in document scanners, the control section 40 may compress the character portions at a low compression rate and compress portions other than the characters at a high compression rate.

When the bit information indicates monochrome, the size of the image IM0 will be equal to or less than the upper limit, and thus the control section 40 converts the cut-out image IM0 into monochrome without compressing the cut-out image (S214).

After S212 or S214 is processed, the control section 40 adds image information indicating the width and the height of the image IM0 to the image IM0 (S216), and ends the scan process.

When the first surface scan process of S104 illustrated in FIG. 8 is completed, the control section 40 causes the display section 50 to display a reading completed screen 580 illustrated in FIG. 9, and determines whether or not to read the second surface F2 of the document D0 (S106). The reading completed screen 580 includes a "start reading" button 581, a "no back side" button 582, a scan operation setting region 583, and the like. When the control section 40 receives an operation on the "start reading" button 581 via the operation section 51, the control section 40 advances the process to S108. When the control section 40 receives an operation on the "no back side" button 582 via the operation section 51, the control section 40 advances the process to S110. When the control section 40 receives an operation on the scan operation setting region 583 via the operation section 51, the control section 40 causes the display section 50 to display the details setting screen 540 illustrated in the lower part of FIG. 7, and receives a change of the scan settings.

In S108, the control section 40 causes the display section 50 to display the scanning display screen 560 illustrated in FIG. 9, performs the second surface scan process for reading the second surface F2 of the ID card D01, and then advances the process to S112 to a perform layout generation process. As described above, the second surface scan process can be performed according to the flow illustrated in FIG. 10, for example.

In S110, the control section 40 sets a no image information flag FLN for the second image IM2, sets both the width and the height of the second image IM2 to 0, then advances the process to S112 and performs the layout generation process.

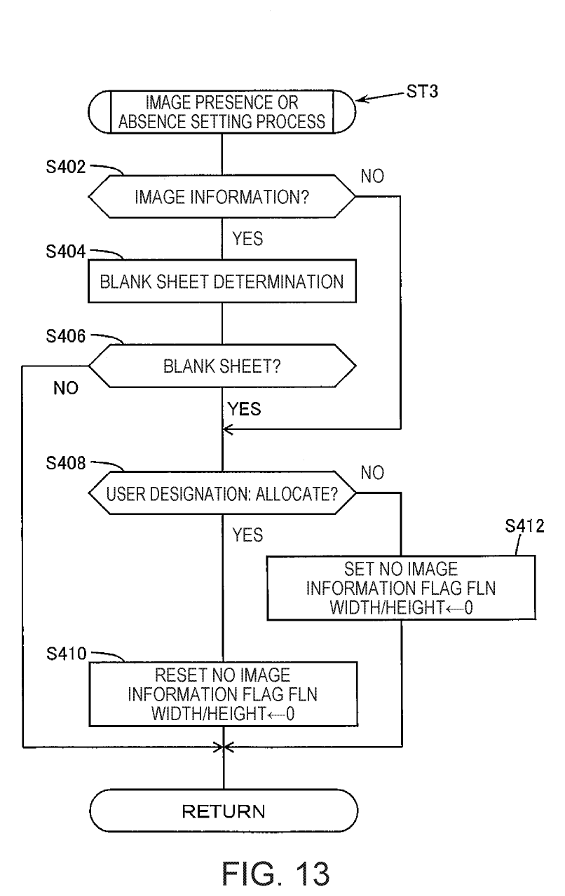

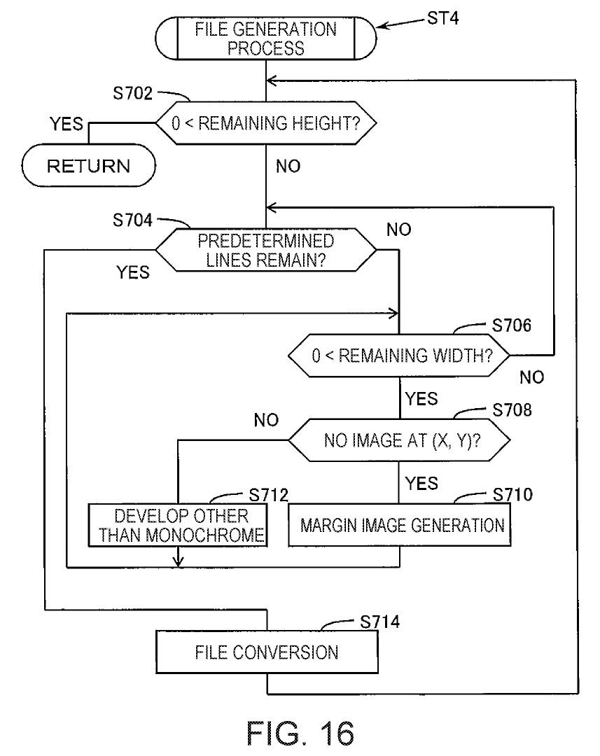

FIG. 12 schematically illustrates the layout generation process performed by the control section 40. FIG. 13 schematically illustrates an example of the image presence or absence setting process performed in S302 and S304. FIG. 14 schematically illustrates the composite image generation process. The size determination step ST3 is executed, and the size determination process is performed, by the image presence or absence setting process and the composite image generation process. A part of the composite image output step ST4 is executed, and a part of the composite image output process is performed, by the composite image generation process. FIG. 15 schematically illustrates the two image allocation process performed in S512 illustrated in FIG. 14. A part of the size determination step ST3 is executed, and a part of the size determination process is performed, by the two image allocation process. FIG. 16 schematically illustrates the file generation process. A part of the composite image output step ST4 is executed, and a part of the composite image output process is performed, by the file generation process.

First, an outline of the layout generation process illustrated in FIG. 12 will be described. When the layout generation process is started, the control section 40 performs a first surface image presence or absence setting process of setting the presence or absence of a first image IM1 corresponding to the first surface F1 of the ID card D01 (S302). The control section 40 performs a second surface image presence or absence setting process of setting the presence or absence of a second image IM2 corresponding to the second surface F2 of the ID card D01 (S304). As described above, the processes of S302 and S304 are performed according to the image presence or absence setting process of FIG. 13. After the process of S304, the control section 40 determines whether neither the first image IM1 nor the second image IM2 exists or at least one of them exists, that is, whether both of the no image information flag FLN for the first image IM1 and the no image information flag FLN for the second image IM2 are set (S306). When both no image information flags FLN are set, the control section 40 ends the layout generation process. When at least one of the first image IM1 and the second image IM2 exists, the control section 40 performs the composite image generation process illustrated in FIG. 14 (S308) and ends the layout generation process.

Next, the image presence or absence setting process performed in S302 and S304 will be described in accordance with FIG. 13.

When the image presence or absence setting process is started, the control section 40 determines that there is image information if the no image information flag FLN is not set, and determines that there is no image information if the no image information flag FLN is set (S402). Note that in the image reading process illustrated in FIG. 8, since the no image information flag FLN is provided for the second image IM2, what determines that there is no image information is the case of the second surface image presence or absence setting process of FIG. 12. The control section 40 advances the process to S404 when there is image information, and advances the process to S408 when there is no image information.

In S404, the control section 40 performs a blank sheet determination process of determining whether or not the image IM0 is a blank sheet 230. Note that the first image IM1 is the target of the determination in the first surface image presence or absence setting process of S302 illustrated in FIG. 12 and that the second image IM2 is the target of the determination in the second surface image presence or absence setting process for S304 illustrated in FIG. 12. For example, when the control section 40 determines that the image IM0 section can be regarded as a uniform color such as a single white color, the control section 40 determines that the image is a blank sheet 230. Then, the control section 40 branches the process depending on whether or not the image IM0 is a blank sheet 230 (S406). The control section 40 advances the process to S408 when the image IM0 is a blank sheet 230, and ends the image presence or absence setting process when the image IM0 is not a blank sheet 230.

In S408, the control section 40 branches the process depending on whether or not the allocation of the blank sheet 230 is set in the blank sheet allocation setting region 543 illustrated in FIG. 7. When the allocation of the blank sheet 230 is set, the control section 40 resets the no image information flag FLN, sets both the width and the height of the image IM0 to 0 (S410), and ends the image presence or absence setting process. Note that in the first surface image presence or absence setting process of S302 illustrated in FIG. 12, the no image information flag FLN for the first image IM1 is reset, and the width and height of the first image IM1 are set to 0. In the second surface image presence or absence setting process of S304 illustrated in FIG. 12, the no image information flag FLN for the second image IM2 is reset, and the width and height of the second image IM2 are set to 0. When allocation of the blank sheet 230 is not set, the control section 40 sets the no image information flag FLN, sets both the width and the height of the image IM0 to 0 (S412), and ends the image presence or absence setting process. Note that in the first surface image presence or absence setting process of S302 illustrated in FIG. 12, the no image information flag FLN for the first image IM1 is set, and the width and height of the first image IM1 are set to 0. In the second surface image presence or absence setting process of S304 illustrated in FIG. 12, the no image information flag FLN for the second image IM2 is set, and the width and height of the second image IM2 are set to 0.

Further, the composite image generation process performed in S308 illustrated in FIG. 12 will be described with reference to FIGS. 14 to 16.

When the composite image generation process is started, the control section 40 determines whether or not there is both the first image IM1 and the second image IM2 (S502). In a case where neither the no image information flag FLN for the first image IM1 nor the no image information flag FLN for the second image IM2 is set, both the first image IM1 and the second image IM2 are present, and thus the control section 40 advances the process to S512. In a case where one of the no image information flag FLN for the first image IM1 and the no image information flag FLN for the second image IM2 is set, then either the first image IM1 or second image IM2 is absent, and thus the control section 40 advances the process to S504.

In the description of S504 to S510, the first image IM1 or the second image IM2 will be simply referred to as an image IM0. In S504, the control section 40 sets the layout width of the composite image IM5 to a width obtained by adding the left margin width and the right margin width to the width of the image IM0. Note that the width of the margins are smaller than the width of the image IM0, and are not particularly limited, but may be about 1 to 5 mm. In S506, the control section 40 sets the layout height of the composite image IM5 to a height obtained by adding the upper margin height and the lower margin height to the width of the image IM0. Note that each margin height is lower than the height of the image IM0, and is not particularly limited, but may be about 1 to 5 mm. In S508, the control section 40 sets the X coordinate setting from 0 to the left margin end position as the margin, then sets the X coordinate setting from after that to the end position of the image IM0 as the image, and then sets the X coordinate setting from after that to the right margin end position as the margin. In S510, the control section 40 sets the Y coordinate setting from 0 to the upper margin end position as the margin, then sets the Y coordinate setting from after that to the end position of the image IM0 as the image, and then sets the Y coordinate setting from after that the lower margin end position as the margin. Thereafter, the control section 40 advances the process to S514, and performs the file generation process illustrated in FIG. 16. The file generation process will be described in detail later.

As described above, in the processes illustrated in FIGS. 12 to 14, in a case where the blank sheet allocation setting indicates that no blank sheet 230 is to be included in the composite image IM5 and also one of the first image IM1 and the second image IM2 is a blank sheet 230, the control section 40 determines the size of the composite image IM5 without including the blank sheet 230.

In S512, the control section 40 performs the two image allocation process illustrated in FIG. 15. First, the control section 40 branches the process depending on whether or not the width and the height of the first image IM1 are 0, that is, whether or not the first image IM1 is set to be a blank sheet 230 (S602). When the width and height of the first image IM1 are 0, the control section 40 sets the width and height of the first image IM1 to the width and height of the second image IM2 (S606), generates the first image IM1 as a blank sheet 230 having the same size as the second image IM2, and advances the process to S610. When the width and height of the first image IM1 are not 0, the control section 40 branches the process depending on whether or not the width and height of the second image IM2 are 0, that is, whether or not the second image IM2 is set to be a blank sheet 230 (S604). When the width and height of the second image IM2 are 0, the control section 40 sets the width and height of the second image IM2 to the width and height of the first image IM1 (S608), generates the second image IM2 as the blank sheet 230 having the same size as the first image IM1, and advances the process to S610. When the width and height of the first image IM1 are not 0 and also the width and height of the second image IM2 are not 0, the control section 40 advances the process to S610.

In S610, the control section 40 branches the process depending on whether the landscape layout 220 or the portrait layout 210 is set in the layout selection region 522 illustrated in FIG. 7. When the landscape layout 220 is set, the control section 40 performs processes of S612 to S618. When the portrait layout 210 is set, the control section 40 performs the processes of S620 to S626.

Referring also to FIG. 4, the processes in the case where the landscape layout 220 is selected will be described. In S612, the control section 40 sets the layout width ΣXi of the composite image IM5 to a width obtained by adding the width X1 of the first image IM1, the width X2 of the second image IM2, the left margin width X3, the intermediate margin width X4, and the right margin width X5. Here, a variable i is a variable for identifying each width. Note that X3 < X1, X3 < X2, X4 < X1, X4 < X2, X5 < X1, and X5 < X2 In S614, the control section 40 sets the layout height ΣYi of the composite image IM5 to a height obtained by adding the higher height Y1 of the first image IM1 and the second image IM2, the upper margin height Y3, and the lower margin height Y5. Here, a variable i is a variable for identifying each width. Note that Y3 <Y1 and Y5 <Y1. In S614, the control section 40 determines the size of the composite image IM5 in the second direction D2, which intersects the first direction D1 in which the first image IM1 and the second image IM2 are arranged, to be a size obtained by adding the margin B0 that is the larger one of the first image IM1 and the second image IM2. In S616, the control section 40 sets the X coordinate setting from 0 to the left margin end position as the margin B0, sets the X coordinate setting from after that to the end position of the first image IM1 as the first image, sets the X coordinate setting from after that to the intermediate margin end position as the margin B0, sets the X coordinate setting from after that to the end position of the second image IM2 as the second image, and sets the X coordinate setting from after that to the right margin end position as the margin B0. In S618, the control section 40 sets the Y coordinate setting from 0 to the upper margin end position as the margin B0, sets the Y coordinate setting from after that to the higher end position of the first image IM1 and the second image IM2 as the image, and sets the Y coordinate setting from after that to the lower margin end position as the margin B0. Thereafter, the control section 40 ends the two image allocation process.

Referring also to FIG. 3, a process in the case where the portrait layout 210 is selected will be described. In S620, the control section 40 sets the layout width ΣXi of the composite image IM5 to the sum of the wider one of the widths X1 of the first image IM1 and the second image IM2, the left margin width X3, and the right margin width X5. Note that X3 <X1 and X5 <X1. In S620, the control section 40 determines the size of the composite image IM5 in the second direction D2, which intersects the first direction D1 in which the first image IM1 and the second image IM2 are arranged, to be a size obtained by adding the margin B0 to the larger one of the first image IM1 and the second image IM2. In S622, the control section 40 sets the layout height ΣYi of the composite image IM5 to a height obtained by adding the height Y1 of the first image IM1, the height Y2 of the second image IM2, the upper margin height Y3, the intermediate margin height Y4, and the lower margin height Y5. Note that Y3 < Y1, Y3 < Y2, Y4 < Y1, Y4 < Y2, Y5 < Y1, and Y5 < Y2 In S624, the control section 40 sets the X coordinate setting from 0 to the left margin end position as the margin B0, then sets the X coordinate setting from after that to the end position of the wider one of the first image IM1 and the second image IM2 as the image, and then sets the X coordinate setting from after that to the right margin end position as the margin B0. In S626, the control section 40 sets the Y coordinate setting from 0 to the upper margin end position as the margin B0, sets the Y coordinate setting from after that to the end position of the first image IM1 as the first image, sets the Y coordinate setting from after that to the intermediate margin end position as the margin B0, sets the Y coordinate setting from after that to the end position of the second image IM2 as the second image, and sets the Y coordinate setting from after that to the lower margin end position as the margin B0. Thereafter, the control section 40 ends the two image allocation process.

Note that in any case, the respective margin widths are not particularly limited, but may be about 1 to 5 mm, and the respective margin heights are not particularly limited, but may be about 1 to 5 mm.

As described above, the control section 40 performs the size determination process of determining the size of the composite image IM5 including the first image IM1 and the second image IM2 and including the predetermined margin B0, based on the size of the first image IM1 and the size of the second image IM2. In the processes of FIGS. 12 to 15, when the blank sheet allocation setting indicates that a blank sheet 230 is included in the composite image IM5 and also that one of the first image IM1 and the second image IM2 is the blank sheet 230, the control section 40 determines the size of the composite image IM5 including the blank sheet 230.

When the two image allocation process illustrated in FIG. 15 is completed, the control section 40 advances the process to S514 illustrated in FIG. 14, and performs the file generation process illustrated in FIG. 16.

In this example, in the file generation process illustrated in FIG. 16, the generation of the composite image IM5 and the format conversion are sequentially performed in a unit of a predetermined number of lines in order to suppress the amount of memory used. By this, for example, it is sufficient to have a memory size of 4M bytes for the first image IM1, a memory size of 4M bytes for the second image IM2, and a memory size of several Mbytes for the composite image IM5, which varies depending on the output size. In total, a memory capacity of about several tens of Mbytes is sufficient.

When the file generation process illustrated in FIG. 16 is started, the control section 40 sequentially sets (X, Y) coordinates of a process target in the portrait layout 210 or the landscape layout 220, and performs processes in pixel units. First, the control section 40 determines whether or not the height of the unprocessed portion of the layout (210, 220) is larger than 0, that is, whether or not an unprocessed portion of the layout (210, 220) remains in the Y direction (S702). When no unprocessed portions remain in the layout (210, 220), the file conversion of the composite image IM5 is completed, and thus the control section 40 ends the file generation process.

When unprocessed portions remain in the layout (210, 220), the control section 40 determines whether or not a predetermined number of lines that can be converted in S714 into a file remain (S704). For example, when the file format of the composite image IM5 is JPEG format, the number of lines that can be converted into JPEG is the predetermined number described above. When the predetermined number of lines do not remain, the control section 40 determines whether or not an unprocessed portion of lines of the layout (210, 220) remains in the X direction (S706). When a portion of the lines remain unprocessed, the control section 40 determines whether or not there is an image IM0 (the first image IM1 or the second image IM2) at the (X, Y) coordinates, that is, whether or not the (X, Y) coordinates are a margin B0 (S708). When the (X, Y) coordinate is a margin B0, the control section 40 generates a margin image at the (X, Y) coordinates (S710), shifts the (X, Y) coordinates of the process target by one pixel in the X direction, and returns the process to S706. When there is an image IM0 at the (X, Y) coordinates, the control section 40 sets information of the image IM0 to the (X, Y) coordinates if the image IM0 is monochrome, and expands the information of the image IM0 and sets the information to the (X, Y) coordinates if the image IM0 is other than monochrome (S712). Then, the control section 40 shifts the (X, Y) coordinates of the process target by one pixel in the X direction, and returns the process to S706.

In S706, when there is no unprocessed portion of the line, the control section 40 shifts the (X, Y) coordinates of the process target by one pixel in the Y direction, returns the X coordinate to the initial value, and returns the process to S704.

When the predetermined number of lines are accumulated in S704, the control section 40 converts the predetermined number of lines so as to be in the file format set in the format setting region 542 illustrated in FIG. 7 (S714). Then, the control section 40 shifts the (X, Y) coordinates of the process target by one pixel in the Y direction, returns the X coordinate to the initial value, and returns the process to S702.

As described above, when the composite image IM5 includes the first image IM1 and the second image IM2, the control section 40 generates the composite image IM5 by allocating the first image IM1 and the second image IM2 within the range of the determined size. At this time, the control section 40 generates the composite image IM5 by arranging the first image IM1 and the second image IM2 in the first direction D1 with a space therebetween. Even when the first image IM1 and the second image IM2 have different sizes, the control section 40 generates the composite image IM5 with the size ratio between the first image IM1 and the second image IM2 maintained. Since the generation of the composite image IM5 and the file conversion are sequentially performed in units of a predetermined number of lines, the memory size required for processes can be reduced.

Note that when the image reading device 1 includes a large-capacity storage section such as a hard disk drive, the control section 40 may perform file conversion of the composite image IM5 after generation of the composite image IM5 is completed. At this time, the control section 40 may omit the compression process of the image IM0 in the scan process illustrated in FIG. 10, and may omit the expansion process of the image IM0 in association with the compression process.

When the file generation process illustrated in FIG. 16 is completed, then the composite image generation process illustrated in FIG. 14 is completed, the layout generation process illustrated in FIG. 12 is completed, and the control section 40 advances the process to S114 in the image reading process illustrated in FIG. 8. When continuous scanning is set in the page addition setting region 502 illustrated in FIG. 7, the control section 40 causes the display section 50 to display the reading completed screen 600 illustrated in FIG. 9, and determines whether or not to continue continuous scanning (S114). The reading completed screen 600 includes a "start reading" button 601, a "no next document" button 602, a scan operation setting region 603, and the like. When the control section 40 receives an operation on the "start reading" button 601 via the operation section 51, the control section 40 returns the process to S104. When the control section 40 receives an operation on the "no next document" button 602 via the operation section 51, the control section 40 advances the process to S116. When the control section 40 receives an operation on the scan operation setting region 603 via the operation section 51, the control section 40 causes the display section 50 to display a details setting screen 540 illustrated in the lower part of FIG. 7, and receives a change in the scan setting.

When continuous scanning is not set in the page addition setting region 502 illustrated in FIG. 7, the control section 40 determines in S114 that the continuous scanning is not to be continued, and advances the process to S116.

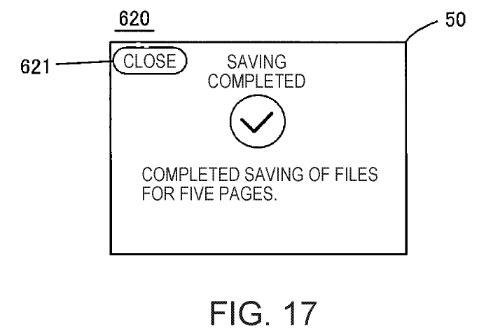

In S116, the control section 40 outputs the composite image IM5 of one or more pages generated in the layout generation process of S112 as a file in the file format set in the format setting region 542 illustrated in FIG. 7. The control section 40 causes the display section 50 to display a storage completed screen 620 illustrated in FIG. 17. The storage completed screen 620 includes a "close" button 621 and the like. When the control section 40 receives an operation on the "close" button 621 via the operation section 51, the control section 40 ends the image reading process illustrated in FIG. 8.

As described above, the output of the composite image IM5 may be transmission to the host device 100 or printing by the printing section 55.

As described above, the control section 40 generates the composite image IM5 by allocating the first image IM1 and the second image IM2 within the range of the determined size and performs the composite image output process of outputting the composite image IM5.

As illustrated in FIGS. 3 and 4, the document D0 may be arranged anywhere in the reading range by cutting out the image IM0 included in the read data DA0 from the background BG0. In addition, since the margin B0 surrounding the first image IM1 and the second image IM2 in the composite image IM5 is small, the first image IM1 and the second image IM2 included in the composite image IM5 are easily viewed. Therefore, in the present example, the outputted image obtained by reading the document D0 having the first surface F1 and the second surface F2 can be made easy to view. Even if the document D0 is arranged to be inclined with respect to the document base 20, the inclination of the image (IM1, IM2) is corrected so that the image (IM5, IM2) included in the composite image IM5 becomes more easy to view. As illustrated in FIG. 5, even when the first image IM1 and the second image IM2 have different sizes, the images (IM5, IM2) included in the composite image IM5 are easily viewed. Further, even if the first image IM1 and the second image IM2 have different sizes, the size ratio between the first image IM1 and the second image IM2 is maintained in the composite image IM5, and therefore, the larger one of the first image IM1 and the second image IM2 is relatively large in the outputted image. In this respect, the images (IM5, IM2) included in the composite image IM5 are easy to view. Further, in a case where the first image IM1 or the second image IM2 is a blank sheet 230, if the setting is such that the blank sheet 230 is to be included in the composite image IM5, then an outputted image to which the blank sheet 230 is allocated is obtained, and if the setting is such that the blank sheet 230 is not to be included in the composite image IM5, then an outputted image in which the blank sheet 230 is not included is obtained. Therefore, the image reading device 1 of this specific example is convenient.

As in the combination 2 illustrated in FIG. 6, one surface of a medium D02 different from the ID card D01 may be used as a second surface F2 and may be combined with the first surface F1 of the ID card D01. When the second surface scan process of S108 illustrated in FIG. 8 is to be performed, the user may place the medium D02 with the second surface F2 facing the document base 20. Of course, the control section 40 may receive in advance a setting as to whether the second surface F2 is to be the ID card D01 or the medium D02, and when the second surface F2 is set to be the medium D02, the control section 40 may cause the display section 50 to display a screen prompting the user to set the medium D02 instead of the reading completed screen 580 illustrated in FIG. 9. In any case, in the composite image output process, the control section 40 generates a composite image IM5 including a first image IM1 derived from the ID card D01 and a second image IM2 derived from the medium D02, including a predetermined margin B0, and outputs the composite image IM5.

As described above, the image reading device 1 can read the ID card D01 and the other medium D02 and output the composite image IM5, which is convenient.

As in the combination 3 illustrated in FIG. 6, both sides of a first medium M1 such as an ID card D01 may be combined with, as a third surface F3, one side of a second medium M2 that is different from the first medium M1. Therefore, the control section 40 can execute the image reading process illustrated in FIG. 18. The image reading process illustrated in FIG. 18 is obtained by adding processes of S132, S134, and S136 to the image reading process illustrated in FIG. 8. Detailed description of S102 to S116 and the processes (ST1 to ST4) described above will be omitted. The third cutting out step ST5 is executed, and the third cutting out process of extracting the third image IM3 from the background BG0 is performed, by the third surface scan process of S134 in FIG. 18.

When the second surface scan process for S108 is completed, the control section 40 causes the display section 50 to display a second surface reading completion screen similar to the reading completed screen 580 illustrated in FIG. 9, and determines whether or not to read the third surface F3 of the second medium M2 (S132). Examples of messages on the second surface reading completed screen are "Set the next document and select ‘start reading’”, “When ‘no next document’ is selected, reading will end”, and the like. The second surface reading completed screen may include a "start reading" button, a "no next document" button, a scan operation setting region, and the like. When the control section 40 receives an operation on the "start reading" button via the operation section 51, the control section 40 advances the process to S134. When the control section 40 receives an operation on the "no back side" button via the operation section 51, the control section 40 advances the process to S136.

In S134, the control section 40 causes the display section 50 to display a screen similar to the scanning display screen 560 illustrated in FIG. 9, performs a third surface scan process of reading the third surface F3 of the second medium M2, and then advances the process to S112 to perform the layout generation process. The third surface scan process can be performed according to the flow illustrated in FIG. 10, for example.

In S136, the control section 40 sets the no image information flag FLN for the second medium M2, sets both the width and the height of the third image IM3 to 0, then advances the process to S112 and performs the layout generation process.

The layout generation process of S112 can be performed by adding the image presence or absence setting process (see FIG. 13) for the third surface F3 before S306 in the layout generation process illustrated in FIG. 12. The composite image generation process for S308 illustrated in FIG. 12 can be performed by adding a for allocating three images (IM1, IM2, IM3) to the composite image generation process illustrated in FIG. 14. That is, in the three image allocation process, the control section 40 determines, based on the size of the first image IM1, the size of the second image IM2, and the size of the third image IM3, the size of the composite image IM5 including the first image IM1, the second image IM2, and the third image IM3, including the margin B0. Then, in the file conversion process illustrated in FIG. 16, the control section 40 generates the composite image IM5 by allocating the first image IM1, the second image IM2, and the third image IM3 within the range of the determined size. For example, when the composite image 243 of the portrait layout of combination 3 illustrated in FIG. 6 is generated, the layout width ΣXi of the composite image IM5 is set to a width obtained by adding the largest width amongst the first image IM1, the second image IM2, or the third image IM3, to the left margin width and the right margin width. The control section 40 sets the layout height ΣYi of the composite image IM5 to a height obtained by adding the height of the first image IM1, the height of the second image IM2, the height of the third image IM3, the uppermost margin height, the margin height between the first image IM1 and the second image IM2, the margin height between the second image IM2 and the third image IM3, and the lowermost margin height. Even when the composite image IM5 is in landscape layout, the composite image IM5 can be generated in the same manner. The composite image IM5 is outputted by performing the file output process in S116 illustrated in FIG. 8.

As described above, the image reading device 1 can read both sides of the first medium M1 and the third surface F3 of the second medium M2 and output the read sides as the composite image IM5, which is convenient. Of course, the document D0 may include a fourth and subsequent surfaces, and the composite image IM5 may include fourth and subsequent images.

### 4. Modifications

The present disclosure includes various modifications.

For example, the document D0 may be read by ADF scanning. In this case, the effect of making it easy to view the output image obtained by reading the document having the first surface and the second surface is also obtained.

The above-described processes can be changed as appropriate, such as by changing the order. For example, in the layout generation process illustrated in FIG. 12, the process of S302 and the process of S304 can be exchanged. In the image reading process illustrated in FIG. 8, the image reading device 1 may always read the second surface F2 of the document D0 by omitting the processes of S106 and S110.

As illustrated in FIG. 19, the control section 40 may perform the image reading process so as to be able to switch between outputting a composite image IM5 illustrated in FIGS. 3 and 4 and outputting the joined image IM6 illustrated in FIGS. 20 and 21. The control section 40 is capable of receiving an output setting for either the composite image IM5 or the joined image IM6 via the operation section 51 in the details setting screen 540 illustrated in the lower part of FIG. 7.

When the image reading process illustrated in FIG. 19 is started, the control section 40 branches the process according to the state of the switch 521 and the output setting in the details setting screen 540 illustrated in FIG. 7 (S802). When the setting according to the state of the switch 521 illustrated in FIG. 7 is not ID card scan, the control section 40 performs the "normal scan process".

When the setting according to the state of the switch 521 illustrated in FIG. 7 is ID card scanning and the output setting indicates outputting the composite image IM5, the control section 40 performs the processes illustrated in FIGS. 3 and 4, for example, the processes after S104 illustrated in FIG. 8 (S804). In this case, the first read data DA1 and the second read data DA2 have a first size, for example, A3 size. As described above, the control section 40 performs the first cutting out process, the second cutting out process, the size determination process, and the composite image output process.

When the setting according to the state of the switch 521 illustrated in FIG. 7 is ID card scan and the output setting indicates output of the joined image IM6, the control section 40 performs the processes illustrated in FIGS. 20 and 21 (S806). In this case, the first read data DA1 and the second read data DA2 have a second size, for example, A5 size, which is larger than the first size. The control section 40 generates a joined image IM6 by connecting the first read data DA1 and the second read data DA2, and outputs the joined image IM6.

As described above, the user can select whether to output the composite image IM5 in which the first image IM1 and the second image IM2 are allocated within the range of the determined size or to output the joined image IM6 in which the read data DA0 of the first surface F1 and the read data DA0 of the second surface F2 are joined. Therefore, the example illustrated in FIG. 19 can improve the convenience of the user.

As illustrated in FIGS. 3 and 4, the margin B0 included in the composite image IM5 includes the first margin B1 for the first image IM1 and the second margin B2 for the second image IM2. In this regard, the control section 40 may be able to receive the size of the first margin B1 and the size of the second margin B2 via the operation section 51 on the details setting screen 540 illustrated in the lower part of FIG. 7. In this case, in the two image allocation process illustrated in FIG. 15, the control section 40 may determine the size of the composite image IM5 including the first image IM1 adjusted to the first margin B1 and the second image IM2 adjusted to the second margin B2. Hereinafter, an example of determining the size of the composite image IM5 using the size of the first margin B1 and the size of the second margin B2 will be described with reference to FIG. 15 and the like.

In S612 illustrated in FIG. 15, the control section 40 sets the layout width ΣXi of the composite image IM5 (see FIG. 4) in the landscape layout 220 illustrated in FIG. 5 to a width obtained by adding the width X1 of the first image IM1, the width X2 of the second image IM2, the width X3 of the first margin B1, the intermediate margin width X4, and the width X5 of the second margin B2. The width X3 may be different from the width V4 or the width X5, and the width X5 may be different from the width X4. In S614, the control section 40 may set the layout height ΣYi of the composite image IM5 to a height obtained by adding the height Y1 of the higher one of the first image IM1 and the second image IM2, the width Y3 of the wider one of the first margin B1 and the second margin B2, and the width Y5 (that is, Y5 = Y3) of the wider one of the first margin B1 and the second margin B2.

In S620 illustrated in FIG. 15, the control section 40 may set the layout width ΣXi of the composite image IM5 in the portrait layout 210 illustrated in FIG. 5 to a width obtained by adding the width X1 that is wider amongst the first image IM1 and the second image IM2, the width X3 that is wider amongst the first margin B1 and the second margin B2, and the width X5 (that is, the X5 = X3) that is wider amongst the first margin B1 and the second margin B2. In S622, the control section 40 sets the layout height ΣYi of the composite image IM5 to a height obtained by adding the height Y1 of the first image IM1, the height Y2 of the second image IM2, the height Y3 of the first margin B1, the intermediate margin height Y4, and the height Y5 of the second margin B2. The height Y3 may be different from the height Y4 or the height Y5, and the height Y5 may be different from the height Y4.

When the two image allocation process illustrated in FIG. 15 is completed, the control section 40 advances the process to S514 illustrated in FIG. 14, and performs the file generation process illustrated in FIG. 16. In the file generation process, the control section 40 generates the composite image IM5 by allocating the first image IM1 aligned with the first margin B1 and allocating the second image IM2 aligned with the second margin B2. When the file generation process is completed, then the composite image generation process illustrated in FIG. 14 is completed, the layout generation process illustrated in FIG. 12 is completed, and the control section 40 advances the process to S114 in the image reading process illustrated in FIG. 8. When scanning is not to be continued, the control section 40 outputs the composite image IM5 as a file in S116 illustrated in FIG. 8.

As described above, the user can separately set the size of the first margin B1 for the first image IM1 and the size of the second margin B2 for the second image IM2. Therefore, the output image can be made more easily viewable, and the convenience of the user can be improved.

### 5. Conclusions

As described above, according to the present disclosure, it is possible to provide a configuration and the like capable of making an output image obtained by reading a document having a first surface and a second surface easy to view, according to various aspects. Of course, the above-described basic operation and effect can be obtained even in an aspect including only the constituent elements according to the independent claims.

A configuration in which the configurations disclosed in the above-described examples are replaced with each other or the combination thereof is changed, a configuration in which the configurations disclosed in the known art and the above-described examples are replaced with each other or the combination thereof is changed, and the like can also be implemented. The present disclosure also includes these configurations and the like.

What is claimed is:

1. An image reading device comprising:
a reading section configured to read a document having a first surface and a second surface and
a control section configured to perform processes on read data generated by the reading section, wherein
the read data includes first read data generated by reading the first surface and second read data generated by reading the second surface and
the control section performs
a first cutting out process of, based on the first read data, extracting, from a background, a first image corresponding to the first surface,
a second cutting out process of, based on the second read data, extracting, from a background, a second image corresponding to the second surface,
a size determination process of determining, based on a size of the first image and a size of the second image, a size of a composite image that includes the first image and the second image and that includes a predetermined margin, and
a composite image output process of generating the composite image by allocating the first image and the second image within a range of the determined size, and outputting the composite image.

2. The image reading device according to claim 1, wherein
the control section
in the first cutting out process, calculates an inclination of the first image based on the first read data, and performs inclination correction of the first image based on the inclination and
in the second cutting out process, calculates an inclination of the second image based on the second read data, and performs inclination correction of the second image based on the inclination.

3. The image reading device according to claim 1, wherein
the control section
in the size determination process, determines the size, in a second direction intersecting a first direction in which the first image and the second image are arranged, of the composite image to be a size obtained by adding the margin to a larger one of the first image and the second image and
in the composite image output process, generates the composite image by arranging the first image and the second image with a space therebetween in the first direction.

4. The image reading device according to claim 1, wherein
in the composite image output process, the control section generates the composite image in which a size ratio between the first image and the second image is maintained even when the first image and the second image have different sizes.

5. The image reading device according to claim 1, wherein
the control section
is configured to receive a blank sheet allocation setting as to whether or not the blank sheet is to be included in the composite image if one of the first image and the second image is a blank sheet,
when the blank sheet allocation setting indicates that a blank sheet is to be included in the composite image and when one of the first image and the second image is a blank sheet, determines the size of the composite image to include the blank sheet in the size determination process, and
when the blank sheet allocation setting indicates that a blank sheet is not to be included in the composite image and one of the first image and the second image is a blank sheet, determines the size of the composite image without including the blank sheet in the size determination process.

6. The image reading device according to claim 1, wherein
the document includes an ID card having the first surface and a medium that is different from the ID card and that has the second surface and
in the composite image output process, the control section outputs the composite image including the first image derived from the ID card and the second image derived from the medium.

7. The image reading device according to claim 1, wherein
the document includes a first medium having the first surface and the second surface on an opposite side from the first surface, and a second medium that is different from the first medium and that has a third surface,
the read data includes third read data generated by reading the third surface, and
the control section
performs a third cutting out process of, based on the third read data, extracting, from a background, a third image corresponding to the third surface;
in the size determination process, determines, based on the size of the first image, the size of the second image, and a size of the third image, the size of the composite image that includes the first image, the second image, and the third image and that includes the margin, and
in the composite image output process, the composite image is generated by allocating the first image, the second image, and the third image within the range of the determined size.

8. The image reading device according to claim 1, wherein
the control section is configured to receive an output setting as to whether or not to output the composite image,
in a case where the output setting indicates that the composite image is to be output,
the first read data and the second read data have a first size and
the control section performs the first cutting out process, the second cutting out process, the size determination process, and the composite image output process, and
in a case where the output setting indicates that the composite image is not to be output,
the first read data and the second read data have a second size smaller than the first size and
the control section generates a joined image by connecting the first read data and the second read data together, and outputs the joined image.

9. The image reading device according to claim 1, wherein
the margin includes a first margin for the first image and a second margin for the second image and
the control section
is configured to receive a size of the first margin and a size of the second margin,
in the size determination process, determines the size of the composite image including the first image aligned with the first margin and the second image aligned with the second margin, and
in the composite image output process, generates the composite image by allocating the first image aligned with the first margin and allocating the second image aligned with the second margin.

10. An image reading method of reading a document having a first surface and a second surface by a reading section and performing processes on read data generated by the reading section, the read data including first read data generated by reading the first surface and second read data generated by reading the second surface, the image reading method comprising:
a first cutting out step of, based on the first read data, extracting, from a background, a first image corresponding to the first surface;
a second cutting out step of, based on the second read data, extracting, from a background, a second image corresponding to the second surface;
a size determining step of, based on a size of the first image and a size of the second image, determining a size of a composite image that includes the first image and the second image and that includes a predetermined margin; and
a composite image output step of generating the composite image by allocating the first image and the second image within the range of the determined size, and outputting the composite image.
